(19) United States
(12) Patent Application Publication
(10) Pub. No.: US 2026/0289858 A1
(43) Pub. Date: Sep. 24, 2026

(54) SYSTEM

(71) Applicant: SoftBank Group Corp., Tokyo (JP)

(72) Inventor: Takeshi KOHAMA, Tokyo (JP)

(73) Assignee: SoftBank Group Corp., Tokyo (JP)

(21) Appl. No.: 19/567,005

(22) Filed: Mar. 14, 2026

(30) Foreign Application Priority Data
Mar. 19, 2025 (JP) 2025-045141

(51) Int. Cl. G06T 11/60; G06N 3/0475

(52) U.S. Cl. CPC G06T 11/60; G06N 3/0475

(57) ABSTRACT

A system includes a processor that is configured to receive, as input, information including past visual data, location information, record data, and schedule information, analyze the received information and generate a storyline that depicts a life of a specific individual based on the analyzed information, and create a visual representation based on the generated storyline by using a generative AI model.

### CROSS-REFERENCE TO RELATED APPLICATION

This application is based on and claims priority under 35 USC 119 from Japanese Patent Application No. 2025-045141 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for creating visual works, such as comics, illustrated diaries, or life-log visualizations, from personal data are heavily dependent on manual operations by a creator or user. A user typically has to select past visual data, such as photos and videos, manually interpret location information, record data, and schedule information, and then manually design a storyline that depicts the life of a specific individual. This process is time-consuming, requires considerable skill in narrative composition, and is not easily scalable or adaptable for different users. Furthermore, existing systems that employ generative AI models for image or video generation generally require the user to prepare detailed prompts, and do not automatically integrate heterogeneous personal data to form a coherent, life-spanning storyline. As a result, such systems are unable to provide an automated and personalized storytelling experience that fully reflects the user's past experiences.

Additionally, conventional systems pay insufficient attention to the emotional aspect of the user. Even when personal data is used, the user's emotions or affective states associated with particular events are not systematically analyzed or reflected in the generated storyline. This often leads to visual works that feel generic and fail to match the user's subjective memories or feelings.

Moreover, there is no adequate mechanism in conventional systems that allows the user to specify, in natural language, a particular event or period on which the user wishes to focus, and then have the system automatically construct appropriate prompts for a generative AI model to generate a storyline and corresponding visual expressions. Users are therefore forced to either accept fully automatic but opaque generation, or to manually craft complex prompts, which degrades usability and limits adoption by non-expert users. Therefore, there is a need for a system that can automatically receive and analyze various types of personal information, generate a storyline that depicts the life of a specific individual, reflect the user's emotional states in that storyline, and flexibly handle user instructions expressed in natural language, thereby enabling automatic generation of personalized visual representations using a generative AI model.

### SUMMARY

In order to solve the above-described problems, a system according to one aspect of the present invention comprises a processor, wherein the processor is configured to receive, as input, information including past visual data, location information, record data, and schedule information, analyze the received information, and generate a storyline that depicts a life of a specific individual based on the analyzed information. By automatically integrating heterogeneous personal data, such as images, videos, positional logs, diaries, and calendar information, the processor constructs a coherent narrative structure that represents events and transitions in the individual's life, thereby eliminating the need for manual storyline design by the user.

The processor is further configured to create a visual representation based on the generated storyline by using a generative AI model. In particular, the processor generates or selects prompts or control signals for the generative AI model in accordance with scenes, events, and attributes contained in the storyline, so that the generative AI model automatically outputs images, image sequences, or other visual content corresponding to the storyline. As a result, personalized visual works, such as comics or illustrated stories, can be produced efficiently and consistently from the underlying personal data.

In another aspect, the processor is configured to analyze an emotion of a user and adjust the storyline based on a result of the analysis. For example, the processor may infer the user's emotional state from the content of record data, such as diary text, from user feedback, or from other affective signals, and then modify the selection, order, or emphasis of events in the storyline so that emotionally significant events are highlighted or represented with appropriate intensity. This allows the generated storyline and visual representation to better match the user's subjective experience and desired emotional tone.

In a further aspect, the processor is configured to receive, from the user in natural language, a specification of an event on which the user desires to focus, and to generate a prompt sentence that instructs the generative AI model to generate the storyline based on the specified event. By parsing a natural language input such as “please focus on my graduation day” or “create a story about my first year at university,” the processor identifies the relevant time period, location, or event category within the personal data, selects corresponding events, and then constructs one or more prompt sentences suitable for the generative AI model. This enables the user to intuitively control the focus of the generated storyline and visual representation without manually crafting complex prompts.

Through these configurations, the system according to the present invention can automatically generate a personalized, emotionally adapted storyline from diverse personal data, and can efficiently create corresponding visual expressions using a generative AI model, while allowing the user to specify desired focus events in natural language.

The term “processor” refers to any hardware and/or software component, including one or more CPUs, GPUs, ASICs, FPGAs, microcontrollers, or combinations thereof, that executes instructions to perform the functions described in the claims, such as receiving input information, analyzing the information, generating a storyline, and creating a visual representation using a generative AI model.

The term “past visual data” refers to digital data representing visual content associated with past events of an individual, including but not limited to still images, photographs, graphics, and video data, which may contain metadata such as timestamps and location tags.

The term “location information” refers to data indicating a geographical position or area, including but not limited to GPS coordinates, addresses, place names, and any other positional information that can be associated with a time, an event, or past visual data.

The term “record data” refers to data that records past activities, experiences, or states of an individual, including but not limited to diary entries, life logs, textual memos, sensor logs, and other chronological or event-based records that describe the individual's life.

The term “schedule information” refers to data that represents planned or past scheduled events of an individual, including but not limited to calendar entries, to-do items, appointments, and event reminders, each of which may contain a date, a time, and a description.

The term “storyline” refers to a structured representation of events, scenes, or episodes that depicts a life of a specific individual, including temporal order, causal or thematic relationships among events, and associated attributes such as locations, participants, and emotional annotations.

The term “life of a specific individual” refers to a set of events, experiences, and activities associated with a particular person over a period of time, as derived from the person's personal data, including past visual data, location information, record data, and schedule information.

The term “visual representation” refers to any form of output that visually expresses the generated storyline, including but not limited to images, image sequences, comics, illustrated pages, or other graphical content that can be displayed on a screen or printed.

The term “generative AI model” refers to an artificial intelligence model configured to generate new data samples, such as images or other visual content, based on input conditions or prompts, and includes, for example, generative adversarial networks, diffusion models, transformer-based generative models, and other machine-learning models capable of generative tasks.

The term “emotion of a user” refers to an affective state or sentiment of the user, such as happiness, sadness, excitement, anxiety, nostalgia, or other emotional conditions, which may be inferred from record data, user inputs, behavioral signals, or explicit feedback.

The term “natural language” refers to a human language, such as English or Japanese, expressed in text or speech, that is not constrained to a predefined command syntax and can be freely written or spoken by the user to specify an event or intention.

The term “event on which the user desires to focus” refers to a particular episode, time period, situation, or theme in the user's life that the user designates, in natural language, as a focal point for generating the storyline and corresponding visual representation, such as a graduation day, a wedding, or a specific travel period.

The term “prompt sentence” refers to a text string or set of text strings generated by the processor, which describe conditions, content, or styles to be used by the generative AI model, and which instruct the generative AI model to generate a storyline or visual representation in accordance with the specified event or user requirements.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

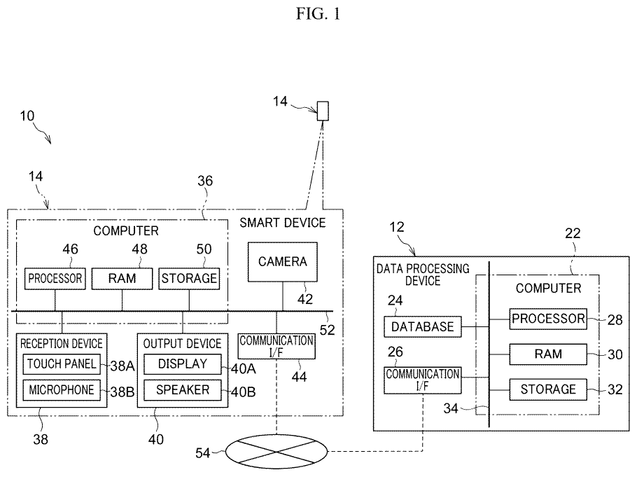

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

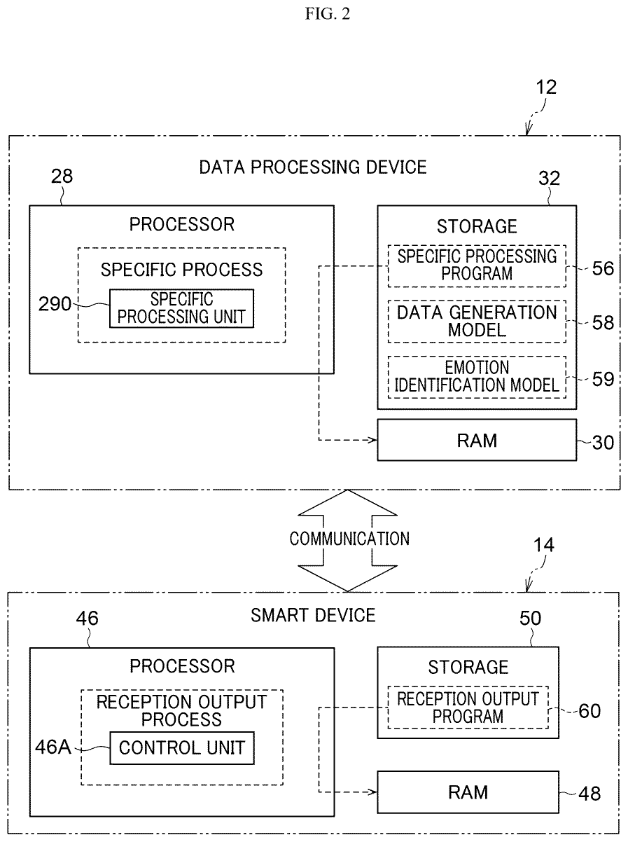

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented systems for reviewing a person's past activities typically treat heterogeneous user data sources, such as visual data, location logs, diary texts, and calendar entries, as separate content streams. Such systems often require a user to manually browse and curate individual photos, text entries, and events, and to manually compose any narrative or visual presentation. As a result, these systems place a significant cognitive and operational burden on the user, and they do not effectively exploit the available computational resources to automatically derive coherent, personalized storylines from large volumes of time-series data.

In addition, existing content generation systems that employ generative artificial intelligence models commonly accept only a free-form prompt sentence as input and rely on the model to infer context, without systematically structuring underlying time-series data, such as visit locations, stay durations, and associated activities. This leads to narratives that are inconsistent with the user's actual records, that lack fine-grained temporal and spatial grounding, or that require extensive manual prompt engineering and trial-and-error adjustments. These shortcomings reflect a limitation in the way computers preprocess and organize heterogeneous time-series data prior to generative processing, rather than merely a limitation in user interface design.

Moreover, conventional systems that generate visual content, such as comics or illustrated stories, typically lack an integrated pipeline that (i) transforms raw user data into structured, episode-level representations, (ii) conditions a generative AI model on those representations together with user-defined prompt sentences, and (iii) automatically segments the generated narrative into machine-usable scene units and visual layout instructions. Consequently, such systems do not fully utilize computational capabilities to improve the efficiency, accuracy, and consistency of data processing, model conditioning, and visual composition.

There is therefore a need for an improved computer-implemented technique that systematically acquires heterogeneous time-series information, performs algorithmic analysis to structure that information into episode-level data, conditions a generative AI model using both this structured data and a prompt sentence, and automatically converts the resulting storyline into visual layouts. Such a technique should reduce the amount of manual curation and prompt engineering required from the user, while improving the technical quality of data handling, model input preparation, and visual output generation in a way that enhances overall computer performance for personalized narrative creation.

The specific processing by the specific processing unit 290 of the data processing device 12 in Example 1 is realized by the following means.

The present invention provides a server comprising a processor and a storage device configured to acquire multiple types of time-series information including past visual information, positional information, record information, and schedule information, to store the acquired multiple types of time-series information in the storage device, to analyze the multiple types of time-series information stored in the storage device by using an information processing program to identify visit locations and stay time periods from the positional information and to perform natural language processing on the record information and the schedule information to extract activity contents and events, to associate the visit locations, the stay time periods, the activity contents, and the events with one another to structure them as time-series episode information, to input the structured episode information and a prompt sentence expressed in natural language as preconditions and provide text information including the prompt sentence to a generative information processing model so as to generate, by the generative information processing model, a storyline that narrates activities and events of a specific person in chronological order, to divide the generated storyline into a plurality of scene units or screen units based on association between the generated storyline and the visual information and to determine, for each of the scene units or the screen units, display text including explanatory text and dialogue text and corresponding visual elements, and to lay out a plurality of component images based on the determined display text and the visual elements by using an image processing program and to generate output data in which the storyline is represented as a visual expression. This enables the server to perform a technically improved end-to-end pipeline in which heterogeneous time-series data are automatically normalized and structured at the episode level, in which a generative AI model is precisely conditioned by both structured episode information and a user-specified prompt sentence, and in which the generated narrative is algorithmically segmented and transformed into visual layouts, thereby reducing manual user operations, improving consistency and fidelity of the generated storyline to the underlying data, and enhancing computational efficiency and reproducibility in personalized narrative and visual content generation.

The term “visual information” refers to information representing visual content, including but not limited to still images, moving images, and associated metadata, that is suitable for being processed, stored, or displayed by an information processing apparatus.

The term “positional information” refers to information indicating a geographic position, including but not limited to coordinate values, such as latitude and longitude, and identifiers of geographic locations, that is associated with a time point or time period.

The term “record information” refers to information that records a user's activities or events in a textual or symbolic form, including but not limited to diary entries, notes, logs, and messages, that can be processed by natural language processing.

The term “schedule information” refers to information that indicates planned or past events or appointments in association with time points or time periods, including but not limited to calendar entries, task items, and event registrations.

The term “time-series information” refers to information that is associated with one or more time points or time periods, and that is processable in chronological order by an information processing apparatus.

The term “storage device” refers to a hardware resource capable of storing digital information, including but not limited to semiconductor memory, magnetic storage, optical storage, and network-accessible storage, that is accessible by a processor.

The term “information processing program” refers to a set of executable instructions that, when executed by a processor, causes the processor to perform data processing operations including reading, writing, transforming, and analyzing digital information.

The term “natural language processing” refers to processing that interprets or manipulates text expressed in a human language, including but not limited to tokenization, syntactic analysis, semantic analysis, named entity recognition, and information extraction.

The term “activity contents” refers to information indicating actions, behaviors, or tasks performed or planned by a user, including but not limited to descriptions such as “visiting a place,” “participating in an event,” or “communicating with another person.”

The term “events” refers to occurrences or happenings associated with a user, a time, and optionally a place, including but not limited to meetings, trips, celebrations, and other discrete incidents identifiable from record information or schedule information.

The term “episode information” refers to structured information representing a unit of experience that includes at least one visit location, a time point or time period, and one or more associated activity contents or events, organized in a form suitable for chronological processing.

The term “prompt sentence” refers to a text expressed in a natural language that specifies conditions, requests, or constraints for content generation, and that is supplied as conditioning information to a generative information processing model.

The term “generative information processing model” refers to a computational model configured to generate output information, such as text or other content, from input information including at least a prompt sentence, by using machine learning, statistical, or rule-based techniques.

The term “storyline” refers to text or structured information that narrates activities and events of a specific person or entity in a coherent manner along a time axis, including references to temporal order, locations, and relationships among events.

The term “scene unit” refers to a segment of the storyline that represents a coherent situation, event, or part of an event, which is treated as a unit for narrative segmentation or for visual composition.

The term “screen unit” refers to a segment corresponding to a single display frame or page, including but not limited to a comic panel, a slide, or a screen in a graphical user interface, that is used as a unit for arranging visual elements and display text.

The term “display text” refers to text intended to be presented to a user in a visual output, including but not limited to explanatory text, narration text, and dialogue text.

The term “visual elements” refers to components of a visual expression, including but not limited to images, icons, backgrounds, frames, and graphic shapes, that are arranged to visually represent a storyline.

The term “component images” refers to images that serve as building blocks of a visual output, including but not limited to user-provided visual information, generated images, and processed images, which are laid out according to layout information.

The term “image processing program” refers to a set of executable instructions that, when executed by a processor, causes the processor to perform operations on image data, including but not limited to resizing, cropping, compositing, and rendering.

The term “output data” refers to digital data generated by the system that represents the storyline as a visual expression, including but not limited to multi-page image data, document data, or data in a format displayable by a user terminal.

The term “emotional state” refers to a condition relating to a user's affect or mood, including but not limited to happiness, sadness, excitement, or calmness, that can be inferred from explicit input, behavioral signals, or other measurable indicators.

The term “emotion analysis result” refers to information obtained by processing data indicative of a user's emotional state, the information including at least one estimated category, intensity, or trend of emotion, which is usable for adjusting generation or presentation of content.

In one embodiment, a server, a terminal, and a user cooperate to implement the invention. The server includes at least one processor, a main memory, a non-volatile storage device, and a network interface. The processor is, for example, a multi-core central processing unit. The storage device is, for example, a magnetic disk device, a solid state drive, or a network-attached storage system. The server executes an operating system, for example a general-purpose server operating system, and executes an application stack that includes a web server module, an application framework, and a set of data processing modules implemented using an interpreted language runtime such as a Python runtime and a database management system such as a relational database management system.

The terminal is, for example, a mobile communication device, a tablet device, or a personal computer equipped with a display, an input interface, a local storage device, and a network communication module. The terminal executes a client application or a browser application that presents a user interface for data upload, query input, and visual result display. The user operates the terminal using an input device such as a touch panel, a keyboard, or a pointing device in order to provide data and instructions to the server.

The server stores in the storage device a database schema that includes at least an image table, a location table, a record table, a schedule table, an episode table, and a storyline table. Each table is physically stored as indexed records in the storage device managed by the database management system. The server defines specific fields in these tables to enable efficient time-series processing and joining. For example, the image table includes fields such as an image identifier, a user identifier, a capture timestamp, a file path, and, optionally, an associated location identifier. The location table includes a location identifier, a user identifier, a timestamp, numeric latitude and longitude values, and optional fields such as a precomputed region identifier. The record table includes a record identifier, a user identifier, a timestamp or data range, and a text field storing diary or note content. The schedule table includes a schedule identifier, a user identifier, a start time, an end time, and a textual description of an event. The episode table includes an episode identifier, a user identifier, a start time, an end time, a place name field, a normalized location identifier, and one or more activity description fields. The storyline table includes a storyline identifier, a user identifier, a reference to an episode sequence, and narrative text.

The server uses a data processing module implemented using a language runtime and an associated library set to perform data loading, transformation, and analysis. The server, in one example, executes a data ingestion module that uses data frame libraries, such as a data frame processing library, to represent tables as in-memory columnar data structures. The server uses vectorized operations provided by the data frame library to sort, group, and join records according to timestamps and user identifiers. The server uses a geographic processing library, such as a geospatial utility library, to perform reverse geocoding and distance calculations on numeric coordinate values. The reverse geocoding process converts numeric position information in the location table into human-readable place names and region identifiers stored in additional fields, for example “city,” “district,” and “point-of-interest identifier.”The server uses a natural language processing library to process the textual contents of the record table and the schedule table. The server loads pre-trained language models, such as a part-of-speech tagging model and a named-entity recognition model, and executes them on the processor to identify token sequences, syntactic dependencies, and semantic entities. The server defines custom extraction rules based on part-of-speech tags and dependency relations to identify activity expressions and event expressions. For example, the server treats verb phrases where verbs are travel-related or interaction-related verbs and their associated noun phrases as candidate activities. The server maps each detected activity expression to a normalized representation stored in one or more columns in the episode table.

The server constructs episode information by algorithmically combining location records and textual records under specific non-conventional rules. The server uses a temporal clustering algorithm in which the server groups consecutive location records that are within a threshold spatial radius and within a threshold temporal gap to define a visit segment. The server sets the threshold spatial radius, for example, as 200 meters and the threshold temporal gap as 30 minutes. The server calculates geodesic distances using the geospatial library and identifies segment boundaries when the user moves beyond the threshold or when the time interval between consecutive location records exceeds the threshold. The server writes each segment into the episode table as an initial episode candidate.

The server then associates record information and schedule information with these episode candidates by joining on an interval intersection condition. The server uses a specialized interval join operation implemented in the data frame library to match records whose timestamps fall within or intersect the start time and end time of each episode candidate. The server aggregates all activity expressions extracted from matching records and assigns them to the corresponding episode entry. This episode construction method is not a mere chronological listing; it forms structured, machine-usable segments that represent coherent stays and their associated activities, optimized for subsequent generative processing.

The server further refines episode information by applying a rule-based consolidation algorithm and, in some embodiments, a clustering algorithm in feature space. The server calculates episode-level feature vectors that include numerical encodings of visit duration, normalized location category identifiers, and activity type counts. The server applies a threshold-based rule to merge episodes that are spatially and semantically related and separated only by short time gaps, thereby reducing fragmentation of the timeline. The server stores consolidated episodes as final episode records and maintains a mapping from original data identifiers to episode identifiers, thereby enabling traceability and efficient retrieval. The server uses a generative AI model implemented as a sequence-to-sequence neural network, for example a transformer-based neural network model. The server deploys the generative AI model either locally on a computation node equipped with a graphics processing unit or remotely through an external inference service. The model includes multiple layers of self-attention blocks, feed-forward networks, and layer normalization units. The server stores model parameters, including weight matrices and bias vectors, in the storage device and loads them into memory at inference time. The server configures the model to accept a sequence of token embeddings that represent both the structured episode information and a prompt sentence expressed in a natural language.

The server encodes episode information into a linearized textual or symbolic representation before feeding it to the generative AI model. For example, the server generates intermediate text of the form:
“Episode 1: Date 2023-07-10, Place: seaside area, Activities: went swimming, had lunch at a seaside cafe.”
“Episode 2: Date 2023-08-01, Place: observatory tower, Activities: took photos, bought souvenirs.”

The server concatenates this intermediate text with the user-specified prompt sentence, such as:
“Please generate a warm and nostalgic storyline based on the places I visited and the events that happened in the summer of 2023, and make it suitable for a short comic.”

The server then forms an input sequence in which special tokens delimit system instruction text, episode list text, and user prompt text. The server uses a tokenizer program that maps characters or subwords to integer token identifiers, and uses an embedding layer of the model to transform these identifiers into dense numeric vectors.

The server configures the generative AI model to run with specific hyperparameters, such as a context window size, a number of attention heads, and a hidden dimension size. The server specifies an output maximum length and a sampling temperature parameter to control diversity. During inference, the model performs multiple matrix multiplications and nonlinear transformations across attention layers. The server uses a beam search or top-k sampling algorithm implemented in the generation module to select a sequence of output tokens with high probability while preserving narrative coherence. The server decodes the generated tokens back into text, which forms the storyline. This detailed conditioning of the generative AI model on structured episode information improves the alignment between the generated narrative and the underlying data and reduces hallucination compared to a baseline that uses only a short free-form prompt.

The server trains the generative AI model or a fine-tuned variant in some embodiments. The server uses a training dataset consisting of pairs of structured episode summaries and human-written storylines. The server defines a loss function, such as a cross-entropy loss over token predictions, and uses a stochastic optimization algorithm, such as an adaptive gradient-based optimizer, to update model parameters. The server processes training data in mini-batches, computes forward passes to obtain predicted token distributions, and performs backpropagation to compute gradients of the loss with respect to model weights. The server updates weights iteratively until convergence criteria are met. In certain embodiments, the server applies data augmentation, such as paraphrasing of activities or random reordering of non-critical sentences, to increase robustness. The server may also perform domain-adaptive pretraining on a corpus of time-series narratives to improve temporal coherence.

The server performs scene segmentation and visual layout generation using algorithmic procedures that operate on the generated storyline text and the episode table. The server first splits the storyline into segments corresponding to episode boundaries by scanning for explicit markers inserted by the model or by matching place names and dates found in the storyline text with metadata stored in the episode table. The server then assigns each segment to a scene unit or a screen unit. The server maintains a scene table that stores, for each scene unit, a reference to an episode identifier, a scene sequence number, and associated portion of the storyline text.

The server uses a layout engine module to compute panel arrangements for each scene unit. The server represents a page as a two-dimensional grid and places rectangular regions (panels) within it. The server selects layout templates from a template library based on the number of episodes to be displayed on a page and the relative importance of each episode as determined by episode duration or activity richness metrics. The server uses heuristic rules to prefer larger panel sizes for episodes with higher importance scores. The server calculates exact panel coordinates in pixel units and stores them in a layout data structure.

The server uses an image processing library, such as a bitmap processing library or a computer vision library, to compose component images into the panel regions. The server retrieves image file paths associated with episodes from the image table, loads the corresponding image data into memory, and resizes and crops the images to fit within the panel rectangles without distortion. The server overlays display text, including narration text and dialogue text, onto the panels by rendering text glyphs using a font rendering engine. The server chooses text placement positions based on panel geometry and collision-avoidance rules that prevent overlap with important image regions, which can be approximated by saliency detection or by designated safe zones in templates. The server then generates rasterized output data, such as multiple image files or a document file, and stores the output data in the storage device.

The terminal accesses the generated visual output via a network communication protocol. The terminal sends a retrieval request specifying a user identifier and a storyline identifier. The server retrieves the corresponding output data from the storage device and streams the data to the terminal. The terminal decodes the received data and renders the images on the display. The user views the visual representation and may provide additional prompt sentences, for example:
“Please focus more on my trip to Enoshima and add more emotional descriptions of that day.”

The terminal transmits the new prompt sentence to the server, which uses the prompt sentence and previously constructed episode information to regenerate or adjust the storyline. The server may, for instance, modify the weights assigned to episodes in the layout engine or update the text generation by passing a revised input sequence to the generative AI model with instructions emphasizing specific episodes.

The server, by structuring heterogeneous input data into episode information and conditioning the generative AI model on this structure, achieves specific technical effects. The server reduces the search space of possible narratives that the model must consider, which leads to faster convergence of generation and fewer decoding steps on average. The server improves accuracy of temporal and spatial references in the generated storyline, thereby reducing logical inconsistencies and correcting misalignment errors that would otherwise require manual editing. The server also improves data management by storing normalized episode records and layout records in separate tables, enabling efficient indexing, caching, and incremental updates when new data are added.

The server, by using data frame libraries and vectorized operations for time-series alignment and interval joins, increases processing throughput compared to naïve iterative algorithms. The server reduces network communication load by performing heavy data processing and layout generation on the server side and transmitting only final or near-final visual output data to the terminal, rather than streaming raw sensor logs or high-volume unprocessed images. These technical effects go beyond mere automation of human tasks; they involve optimization of data structures, algorithms, and model conditioning to improve the functioning of the computer system as a whole.

The server, in some embodiments, implements additional modules to adjust the storyline based on an emotion analysis result. The server acquires data indicative of a user's emotional state, such as self-reported mood tags, interaction patterns, or biometric signals obtained through an external sensor interface. The server applies an emotion classification model, such as a neural network trained on labeled emotion datasets, to infer emotion categories and intensities. The server stores the emotion analysis result alongside episode records. When generating or revising the storyline, the server modifies selection thresholds and emphasis parameters so that episodes associated with strong positive or negative emotions are more prominently represented in the narrative and in the panel layout. This modification is realized as explicit parameter changes in the generative input and layout scoring algorithms, and thus constitutes a technical adjustment of internal processing rather than a purely aesthetic choice. In alternative embodiments, the server may use different neural network architectures, such as recurrent neural networks or convolutional sequence models, instead of transformer-based models, so long as the server encodes structured episode information and prompt sentences and generates storyline text conditioned thereon. The server may also integrate a generative image synthesis model that creates illustrative visual elements, and may combine synthesized images with user-provided images in the panel composition process. In such embodiments, the server defines additional feature vectors describing episode context, feeds them to an image generation model, and uses similar layout rules to place generated images. The server, in other embodiments, may distribute computation across multiple nodes, assigning data ingestion, episode construction, model inference, and layout generation to different physical machines and coordinating them via a message queue system. This distributed configuration further enhances scalability and processing speed for large-scale user data. Regardless of implementation details, the server, the terminal, and the user interact as described above to realize the claimed functions of structured time-series episode construction, generative AI model conditioning using a prompt sentence and episode information, and automatic transformation of a generated storyline into a visual representation.

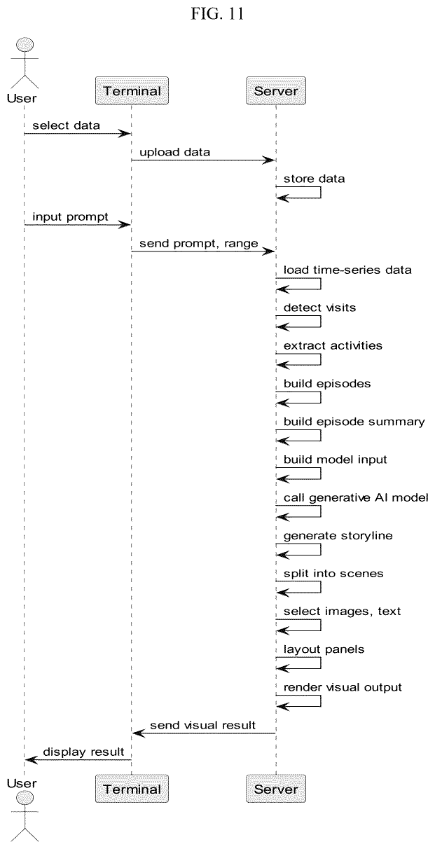

The following describes the processing flow using FIG. 11.
Step 1:

The user operates the terminal to select past visual information, positional information, record information, and schedule information stored on the terminal. The input is raw user data, such as image files, location logs, diary texts, and calendar entries. The terminal reads these data items using an operating system API and converts them into uploadable data structures, such as image binaries with metadata and text fields with timestamps. The output is a set of formatted data objects ready for network transmission.
Step 2:

The terminal transmits the formatted data objects to the server via a network connection. The input is the set of formatted data objects generated in Step 1. The terminal wraps these data objects into one or more network requests and sends them through a communication protocol. The output is a stream of request messages delivered to the server.
Step 3:

The server receives the request messages and stores the included data into a storage device. The input is the stream of request messages from the terminal. The server parses the messages, validates file types and field formats, and writes visual information, positional information, record information, and schedule information into appropriate database tables. The output is a collection of stored records in an image table, a location table, a record table, and a schedule table, each record being indexed by a user identifier and timestamp.
Step 4:

The server constructs time-series data frames from the stored database records. The input is the stored records in the database tables. The server reads these records into in-memory data structures using a data frame library, orders them by timestamp, and groups them by user identifier. The output is a set of ordered data frames representing time-series visual information, positional information, record information, and schedule information.
Step 5:

The server detects visit segments from the positional information. The input is the time-series positional data frame containing timestamps and coordinates. The server computes distances between consecutive coordinates, compares them with a spatial threshold, and detects time gaps larger than a temporal threshold. The server groups consecutive records that satisfy both distance and time constraints into visit segments. The output is a list of visit segments, each segment having a start time, an end time, and a sequence of coordinates.
Step 6:

The server assigns place names and region identifiers to the visit segments. The input is the list of visit segments with representative coordinate points. The server performs reverse geocoding by sending coordinates to a geospatial service and receives human-readable place names and region classifications. The server attaches the place names and region identifiers to corresponding visit segments. The output is an enriched list of visit segments containing temporal ranges, coordinates, and textual place information.
Step 7:

The server extracts activity contents and events from record information and schedule information. The input is the time-series text data frames of diary entries and schedule entries. The server applies natural language processing, such as tokenization, part-of-speech tagging, and named-entity recognition, and identifies verb phrases and associated noun phrases that represent activities and events. The server normalizes these expressions into canonical activity descriptions. The output is a structured list of activity entries, each entry including a timestamp and an activity description.
Step 8:

The server associates activities and events with visit segments to form episode information. The input is the enriched visit segments from Step 6 and the structured activity entries from Step 7. The server compares timestamps of activity entries with time ranges of visit segments and assigns activities whose timestamps fall within or near a segment's time range to that segment. The server aggregates activities per segment and creates episode records including a start time, an end time, a place name, and a list of activities. The output is an episode table or episode list representing time-series episodes.
Step 9:

The server optionally consolidates or filters episodes based on predefined rules. The input is the raw episode list generated in Step 8. The server evaluates episode duration, number of associated activities, and spatial continuity, and merges adjacent episodes that are similar or too short, or removes episodes that do not meet a significance threshold. The output is a refined episode list optimized for subsequent generative processing.
Step 10:

The user inputs a prompt sentence to specify a focus for storyline generation. The input is a free-text instruction entered through a user interface on the terminal, for example: “Please generate a warm and nostalgic storyline based on the places I visited and the events that happened in the summer of 2023, and make it suitable for a short comic.” The terminal captures this text and packages it as a prompt sentence. The output is a prompt sentence ready to be sent to the server.
Step 11:

The terminal transmits the prompt sentence and a target time range to the server. The input is the user-entered prompt sentence and selected time range. The terminal creates a request message including these values and sends it through the network. The output is a server-side request containing a user identifier, a time range, and a prompt sentence.
Step 12:

The server selects episodes relevant to the prompt sentence and target time range. The input is the refined episode list and the received time range and prompt sentence. The server filters the episode list by comparing episode time ranges with the requested time range, and may further filter episodes based on keywords or topics mentioned in the prompt sentence. The output is a subset of episodes that match the temporal and semantic constraints.
Step 13:

The server converts selected episodes into a structured textual summary. The input is the subset of episodes from Step 12. The server formats each episode into human-readable text that includes the date, place name, and activity list, and concatenates these episode descriptions into a summary document. The output is an episode summary text that can be used as conditioning information for a generative AI model.
Step 14:

The server constructs an input sequence for the generative AI model using the episode summary and the prompt sentence. The input is the prompt sentence and the episode summary text. The server concatenates system instruction text, the episode summary, and the user's prompt sentence into a single text, inserts special delimiters, and tokenizes the text into token identifiers using a tokenizer. The output is a sequence of token identifiers representing the combined instruction, episode data, and prompt sentence.
Step 15:

The server generates a storyline using the generative AI model. The input is the sequence of token identifiers created in Step 14. The server feeds the sequence into the generative AI model, which processes the sequence using its neural network architecture and outputs a sequence of predicted token identifiers for the narrative response. The server decodes the predicted token identifiers back into text. The output is a storyline text that narrates the user's activities and events in chronological order.
Step 16:

The server segments the generated storyline into scene units. The input is the storyline text and the episode list used during generation. The server scans the storyline for explicit episode markers, temporal expressions, and place names, and identifies boundaries where the narrative shifts from one episode to another. The server splits the storyline into scene segments and associates each segment with a corresponding episode identifier. The output is a list of scene units, each containing a portion of the storyline text and a reference to an episode.
Step 17:

The server determines visual elements and display text for each scene unit. The input is the list of scene units and the underlying episode data including associated image identifiers. The server selects one or more visual elements, such as user images or generated illustrations, for each scene based on episode metadata. The server also identifies or refines display text for narration and dialogue from the storyline text. The output is a scene specification list including, for each scene, the selected images and the final display text.
Step 18:

The server computes layout information for visual representation. The input is the scene specification list from Step 17. The server assigns scenes to screen units, selects a layout template for each screen, and computes panel positions and sizes in coordinate units. The server associates each panel with one scene, one or more images, and corresponding display text. The output is a layout definition that specifies panel geometries, image placement, and text placement for each screen.
Step 19:

The server renders component images into the defined layout and generates output data. The input is the layout definition, the visual elements, and the display text. The server uses an image processing program to load source images, resize and crop them to fit the panel regions, draw panel borders, and render narration and dialogue text into predetermined positions using a font engine. The server composes all elements into final raster images or a multi-page document. The output is visual output data that represents the storyline as a comic-style or illustrated content.
Step 20:

The terminal retrieves and displays the generated visual output to the user. The input is a retrieval request including identifiers for the visual output and the corresponding data stored on the server. The server sends the visual output data to the terminal, and the terminal decodes and renders the images on its display. The output is a rendered visual representation that the user can view and, if desired, use as a basis for providing additional prompt sentences for further refinement.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content generation systems that utilize personal data such as images, location logs, diaries, and calendar entries typically treat these data sources in isolation and apply generative models in a simple, direct manner. For example, known systems may feed raw text or a collection of images to a generative model and receive a narrative or visual output. However, such systems generally lack: (i) a structured, time-series-centric integration of heterogeneous personal data, (ii) a systematic mechanism for transforming integrated personal history into a machine-oriented narrative structure, and (iii) a dedicated prompt construction process that conditions a generative model to output storylines that can be programmatically converted into page, panel, and layout instructions for visual content. As a result, the generated content is often inconsistent in chronology, poorly aligned with the user's actual experiences, and difficult to convert into structured visual formats such as comics or illustrated timelines.

Furthermore, conventional systems typically do not explicitly separate the roles of (a) integrating multi-modal time-series data, (b) generating narrative structure information including scenes, places, events, and emotions, and (c) transforming that narrative structure into structured control information for downstream visual rendering applications. This lack of separation leads to opaque processing flows, reduced controllability of outputs, and difficulty in optimizing the overall system performance from a computer-technical standpoint, such as data bandwidth usage between components, processing load on generative models, and efficient reuse of intermediate structures.

Additionally, existing solutions often do not provide a robust mechanism for incorporating user focus specifications, such as natural-language instructions indicating particular periods or events of interest, into the machine processing pipeline. In many cases, the user's natural-language intent is interpreted only at a superficial level, without systematically mapping the intent to specific segments of stored time-series data and without generating corresponding structured prompt sentences optimized for generative models. This limits the precision of personalization and prevents efficient, repeatable generation of tailored storylines for different user-specified viewpoints.

From the perspective of computer technology, there is therefore a need for an improved system architecture and processing method that:
(1) programmatically acquires heterogeneous time-series personal data from an information terminal and integrates the data in a unified temporal-spatial structure;
(2) algorithmically generates narrative structure information including scene information, place information, event information, and emotion information, suitable as intermediate machine-readable data;
(3) constructs, from this narrative structure, optimized prompt sentences for a generative AI model, in order to produce structured storyline information that can be systematically parsed and reused; and
(4) converts the generated storyline information into structured visual expression instruction information that can be directly consumed by a visual expression generation application to render multi-page, multi-panel visual content.

There is also a need to technically improve how emotion information and user-specified focus targets are reflected in the processing pipeline, in a way that is explicit, machine-operable, and compatible with the constraints and interfaces of generative AI models and visual rendering applications. The lack of such a pipeline results in inefficient use of computing resources, ad hoc data handling, and limited automation in generating consistent, chronologically accurate visual content from large volumes of personal historical data.

The specific processing by the specific processing unit 290 of the data processing device 12 in Application Example 1 is realized by the following means.

The present invention provides a server comprising a processor configured to acquire, from an information terminal, time-series information including past visual information, location information, record information, and schedule information together with period information or event information specified by a user; to extract the time-series information based on the period information or the event information; to integrate the extracted time-series information based on time information and spatial information and to associate the visual information, the location information, the record information, and the schedule information with one another in chronological order; to generate narrative structure information including scene information, place information, event information, and emotion information based on an integration result; to generate, in a natural language, a prompt sentence for input to a generative AI model based on the narrative structure information; to transmit the prompt sentence to the generative AI model and to cause the generative AI model to generate storyline information representing the narrative structure information; to convert the storyline information into structured data interpretable by a visual expression generation application, and to generate visual expression instruction information including page information, panel information, background information, element information, and text information; and to input the visual expression instruction information to the visual expression generation application, to control the visual expression generation application to generate visual content including a plurality of image data or document data, and to provide the visual content to the information terminal. This enables a computer-implemented pipeline in which heterogeneous time-series personal data are automatically integrated into a machine-readable narrative structure, converted into optimized prompt sentences for a generative AI model, and further transformed into structured control instructions for a visual rendering application, thereby improving the technical efficiency, controllability, and reproducibility of generating chronologically consistent, user-focused visual content.

The term “time-series information” refers to information items each associated with time information, the items being ordered or orderable along a temporal axis, and including at least past visual information, location information, record information, and schedule information.

The term “past visual information” refers to image data, video data, or related visual media and associated metadata that represent past scenes or events experienced or captured by a user.

The term “location information” refers to data indicating a geographical position, including, for example, coordinate values, place identifiers, or other spatial descriptors associated with a time point or time interval.

The term “record information” refers to textual or symbolic data representing past user activities or states, including, for example, diary entries, memos, activity logs, or other user-generated records.

The term “schedule information” refers to structured data representing planned or past events in a temporal schedule, including, for example, calendar entries, appointment records, or task schedules.

The term “period information” refers to data indicating a continuous or discrete time range, including, for example, a start time, an end time, or a set of dates specified by or derived from user input.

The term “event information” refers to data representing a specific occurrence or activity in a user's life, including attributes such as time, place, participants, and associated content.

The term “information terminal” refers to an electronic device operated by a user and configured to communicate with a server, including, for example, a smartphone, a tablet device, a personal computer, or a similar client device.

The term “information processing apparatus” refers to a hardware and software platform including at least one processor and memory, and configured to execute programs for processing the time-series information.

The term “narrative structure information” refers to structured data representing a story-like organization of user-related events, including, at least, scene information, place information, event information, and emotion information arranged in a coherent order.

The term “scene information” refers to data describing a unit of a narrative, including attributes such as a time frame, a place, involved entities, and a summary of actions or situations.

The term “place information” refers to data specifying a location relevant to a scene or event, including, for example, a geographical name, an address, coordinates, or a categorized place type.

The term “emotion information” refers to data representing an inferred or expressed emotional state associated with a scene, an event, or a record, including, for example, qualitative labels or scores indicating emotions such as happiness, sadness, excitement, or anxiety.

The term “storyline information” refers to data generated by a generative AI model that represent a structured sequence of scenes or narrative elements, including temporal order, causal relationships, and descriptive content suitable for further processing.

The term “generative AI model” refers to a machine learning model configured to generate text or other content in response to an input prompt, based on learned parameters and trained data, and executable on a computing infrastructure.

The term “prompt sentence” refers to a natural-language or machine-readable text generated by the server and provided as input to the generative AI model, the text specifying conditions, constraints, or instructions for generating storyline information.

The term “visual expression generation application” refers to software configured to generate visual content, such as images, pages, or panels, based on structured control data, and to render the content as image data or document data.

The term “visual expression instruction information” refers to structured data interpretable by the visual expression generation application, including at least page information, panel information, background information, element information, and text information that specify how visual content is to be composed.

The term “page information” refers to data describing a unit page of visual content, including page size, orientation, and an arrangement of one or more panels.

The term “panel information” refers to data describing a sub-region within a page used to depict a portion of the narrative, including position, size, and associated visual and textual content.

The term “background information” refers to data specifying visual context or scenery for a page or a panel, including, for example, location-based scenery, environmental elements, or stylistic attributes.

The term “element information” refers to data specifying visual components to be placed within a panel or page, including, for example, characters, objects, icons, or other graphical elements and their attributes.

The term “text information” refers to data specifying textual content to be rendered in association with visual content, including narration text, dialogue text, captions, and their placement attributes.

The term “visual content” refers to digital content comprising one or more images, pages, or documents that visually represent a narrative or events based on the visual expression instruction information.

The term “focus-target specification information” refers to information expressed in natural language by the user and indicating a desired focus, such as a particular period, event, or theme, to be emphasized in the generated storyline.

The term “integration result” refers to data obtained by combining and organizing heterogeneous time-series information according to temporal and spatial relationships, producing a coherent, unified representation suitable for narrative generation.

In one embodiment, a server cooperates with one or more terminals operated by a user to implement the claimed system. The server includes at least one processor, a main memory, non-volatile storage, and a network interface. The processor executes a server program stored in the non-volatile storage and loaded into the main memory. The server is connected to a data storage service, for example a document-oriented database and an object storage service, and is accessible from terminals via a communication network such as the Internet. The terminal is, for example, a smartphone, a tablet, or a personal computer including a processor, a memory, a display, and a wireless or wired communication interface. The user operates an application program or a web browser on the terminal to interact with the server.

The server stores and executes multiple software modules that correspond to functional components of the claimed system. In one embodiment, the server runs an application framework such as a web application framework, a database access library, a message serialization layer (for example, JSON-over-HTTP), an authentication module, and a dedicated narrative-generation module. The server further communicates with an external generative AI model service implementing a transformer-based neural network model. In another embodiment, the server hosts the generative AI model locally on a graphics processing unit (GPU)-equipped computation node.

The terminal provides a user interface that allows the user to register with the system, to authenticate, and to grant access to personal historical data. The terminal allows the user to specify a period of interest, such as a calendar range, or an event of interest in natural language, such as “my 2022 summer vacation,” as focus-target specification information. The terminal transmits, under user control, past visual information (such as digital photographs and videos and their metadata), location information (such as position logs recorded by a location sensor), record information (such as diary entries, text memos, or activity logs), and schedule information (such as calendar entries) to the server via a secure connection. The server stores the transmitted data as time-series information in the database. The server represents the time-series information in a unified data structure that includes, for each item, at least a timestamp, a location attribute, a data type attribute (visual, location, record, or schedule), and a reference to the stored content (for example, a uniform resource identifier for an image file in object storage). In one embodiment, the server normalizes timestamps to a consistent temporal format and associates each visual information item with nearby location and record information items based on the timestamps and optional identifiers.

The server implements a data integration module that organizes the time-series information into an integration result. The server uses, for example, a clustering algorithm that groups events occurring within a predetermined temporal window and within a predetermined spatial distance into a single candidate scene. The server uses geospatial libraries and reverse geocoding services to map raw coordinates in the location information to human-readable place names and place categories. The server then constructs narrative structure information that includes a sequence of scene information records. Each scene information record includes at least place information (including a place name and coordinates), event information (including an abstracted action description), associated visual information identifiers, associated record information identifiers, and emotion information inferred from the record information or from previously stored emotion annotations.

In one embodiment, the server infers emotion information by applying a text analysis model to the record information. The server uses, for example, a sentiment classification network implemented as a recurrent neural network or transformer network. The server computes feature vectors for each record information item based on tokenized text, applies a trained classification layer using a softmax function, and assigns an emotion label such as “joy,” “sadness,” or “surprise” with an associated confidence score. The server stores this emotion information in the narrative structure information and uses it to weight or order scenes. The server further constructs a prompt sentence in a natural language for a generative AI model. The server uses a template-based prompt construction subsystem. The server defines template segments, such as a period description segment, a location description segment, a diary highlight segment, a schedule summary segment, and an instruction segment specifying required output structure. The server fills these segments with values derived from the narrative structure information, including explicit dates, place names, summarized diary sentences, and names of notable events. The server then concatenates the segments into a single prompt sentence.

In one concrete example, the server generates the following prompt sentence:
“The user's target period is from Aug. 1, 2022 to Aug. 31, 2022.”

Movement logs show visits to: a central railway station (August 2-3), a historical temple district (August 10-12), and an urban waterfront area hosting a fireworks festival (August 20-22).

Diary highlights include:
‘I met my university friends in the city and felt very nostalgic.’ (August 2)
‘I visited a famous temple and was impressed by the view.’ (August 11)
‘I watched a fireworks festival by the river and felt happy and relaxed.’(August 21)

Schedule entries include: ‘Trip to the historical city’ (August 10-12) and ‘Fireworks with a friend’ (August 21).

Based on this data, please act as a story designer and generate a chronological story line describing the user's summer vacation.

Divide the story into 8-12 scenes.

For each scene, specify:
1) scene title,
2) time or date,
3) place name,
4) main characters,
5) summary of what happens, and
6) suggested visual composition for a comic panel (for example, ‘wide shot of the temple, user in the foreground’).

“Output the result in a structured format that can be parsed programmatically.”

In another example, the server generates a prompt sentence emphasizing a different period:
“From Dec. 24, 2022 to Jan. 1, 2023, the user's data shows:”
Location history: home town, parents'house, local shrine.
Diary notes about Christmas dinner, family reunion, and shrine visit on New Year's Day.
Calendar events: ‘Christmas Party’ (December 25), ‘Family Dinner’ (December 30), ‘First Shrine Visit of the Year’(January 1).

Based on these data, create a story structure of the New Year's holiday, divided into 8 scenes suitable for manga panels.

For each scene, specify the setting, the key activity, one representative line of narration, and a visual suggestion (for example, ‘close-up of family around the table’).

The server transmits the generated prompt sentence to a generative AI model. In one embodiment, the generative AI model is a transformer-based language model having multiple self-attention layers, feed-forward layers, and normalization layers, with parameters trained on large-scale text corpora. The server provides the prompt sentence as input to the generative AI model through an application programming interface. The generative AI model receives tokenized input and produces an output sequence of tokens that the server decodes into text representing storyline information.

The server post-processes the output text from the generative AI model. The server instructs the model via the prompt sentence to output machine-readable structure, for example, labeled sections for each scene. The server parses the output text into a data structure such as an array of scene objects. Each scene object includes a scene title, a date or relative time, a place name, a list of main characters, a summary of actions, and a description of a visual composition. The server thus converts the generated text into structured storyline information.

The server converts the storyline information into visual expression instruction information. The server defines a page and panel layout strategy controlling how scenes map to pages and to panels. In one embodiment, the server uses a rule-based layout algorithm: the server assigns a fixed number of panels per page for certain scene counts, merges short scenes into a single page, or splits long scenes across multiple pages. The server generates panel information for each panel, including coordinates on a page, aspect ratio, and a rendering order. The server attaches background information derived from place information and diary context, such as “night cityscape,” “temple courtyard,” or “family living room.”

The server includes element information specifying, for example, the number and approximate positions of characters, important objects, and text balloons. The server includes text information derived from the storyline information, choosing short narration lines and sample dialogue, and assigns these to styled text elements such as narration boxes or speech balloons. The server encapsulates these datasets as visual expression instruction information interpretable by a visual expression generation application.

In one embodiment, the server controls a visual expression generation application executing on a separate graphical workstation. The visual expression generation application is configured to receive the visual expression instruction information and to generate visual content, such as a multi-page comic, by programmatic control. The server communicates with the visual expression generation application via a scripting interface or an inter-process communication protocol. The visual expression generation application creates new document files, defines physical pages, creates panel frames, adds background layers, draws or composes character layers based on style templates, and renders text layers at specified coordinates. The visual expression generation application then outputs rendered pages as image data files or as a multi-page document file.

The server stores the generated visual content in the storage service and records identifiers in the database. The server returns metadata including uniform resource locators of the visual content to the terminal. The terminal retrieves the visual content and displays the pages on the display. The user views the visual content and can request regeneration by changing the focus-target specification information, such as selecting another period or event.

In this architecture, the server improves computer technology in several respects. First, the server uses a structured narrative structure information layer as an intermediate representation between heterogeneous time-series data and the generative AI model. This reduces redundant data transfer and simplifies subsequent processing. For example, the server summarizes long diary entries before constructing the prompt sentence, thereby reducing token length and network bandwidth usage when interacting with the generative AI model. This directly improves processing speed and reduces computation cost.

Second, the server segregates the functions of data integration, prompt construction, generative model invocation, and visual layout generation into separate modules. Each module uses clearly defined data structures. This modularity enables optimization of each stage; for instance, the server can cache narrative structure information for repeated focus-target specifications, so that subsequent calls to the generative AI model require only incremental updates rather than full regeneration. This leads to lower latency and reduced computing load.

Third, the server uses non-conventional rules and algorithms for mapping narrative structure information to visual expression instruction information. The server does not simply generate generic images but enforces layout constraints and semantic relationships, such as aligning scene order with time order and arranging important scenes in visually prominent positions. The rule-based layout engine and the semantic mapping from scene importance (for example, inferred from emotion information) to panel size improve the clarity of the generated visual content and reduce the need for human post-editing.

Fourth, the server implements a specific training and inference strategy for the generative AI model. In one embodiment, the generative AI model is fine-tuned on synthetic or real narrative data that include structured scene descriptions. The server stores a fine-tuning configuration specifying loss functions that penalize deviations from required output fields, such as missing scene titles or place names. The server, during model training, uses a cross-entropy loss between predicted tokens and target tokens and adjusts weights via gradient descent optimization. The server may apply data augmentation methods, such as shuffling non-critical sentences or injecting synonyms, to improve robustness. This training and inference configuration is tailored to produce outputs that are particularly suited for subsequent programmatic parsing and visual layout, thereby improving the accuracy and reliability of the overall system.

Fifth, the server uses a specific method to incorporate emotion information and focus-target specification information into the prompt sentence and into the subsequent processing. The server numerically encodes emotion strength and scene relevance scores and uses thresholds to select scenes to be emphasized or de-emphasized. The server then explicitly indicates these emphasis instructions in the prompt sentence, for example by adding text phrases such as “highlight the emotional impact of the temple visit” or “treat the fireworks scene as a climax.” This explicit encoding allows the generative AI model to generate storylines that conform to technical constraints determined by the server, leading to more stable and predictable behavior than ad hoc natural-language prompting.

Sixth, the server improves data management by storing narrative structure information and storyline information as concise, structured records separate from the raw media data. This allows the server to index and search narrative elements (such as “all scenes involving a certain place type”) without scanning large image or video files, thereby reducing input/output operations and improving database query performance.

Alternative embodiments are possible. In one alternative, the server executes the generative AI model locally on a GPU server, rather than via an external service. In this case, the server loads model parameters into GPU memory and performs inference by executing matrix multiplication operations on the GPU. In another alternative, the server uses different neural network architectures, such as encoder-decoder models or hybrid models combining convolutional layers for visual feature extraction with transformer layers for text generation, when multimodal inputs are directly passed to the model.

In another embodiment, the terminal performs some preprocessing, such as compressing images or generating low-resolution thumbnails, before transmitting the data to the server. This reduces communication load and accelerates processing on the server side. In another variation, the terminal allows the user to manually correct or adjust scene boundaries or emotion labels in the narrative structure information, and the server integrates these corrections into subsequent prompt construction and layout generation.

In each of these embodiments, the server is not merely automating a human editorial process at a high level but is implementing specific data structures, transformation rules, and neural network configurations that are tightly coupled with hardware resources such as processors, memories, and GPUs. This coupling produces technical effects including reduced latency in content generation, improved consistency and accuracy of generated storylines, better use of storage and network resources, and more efficient processing of heterogeneous personal historical data, thereby providing an improvement in computer-based content generation technology.

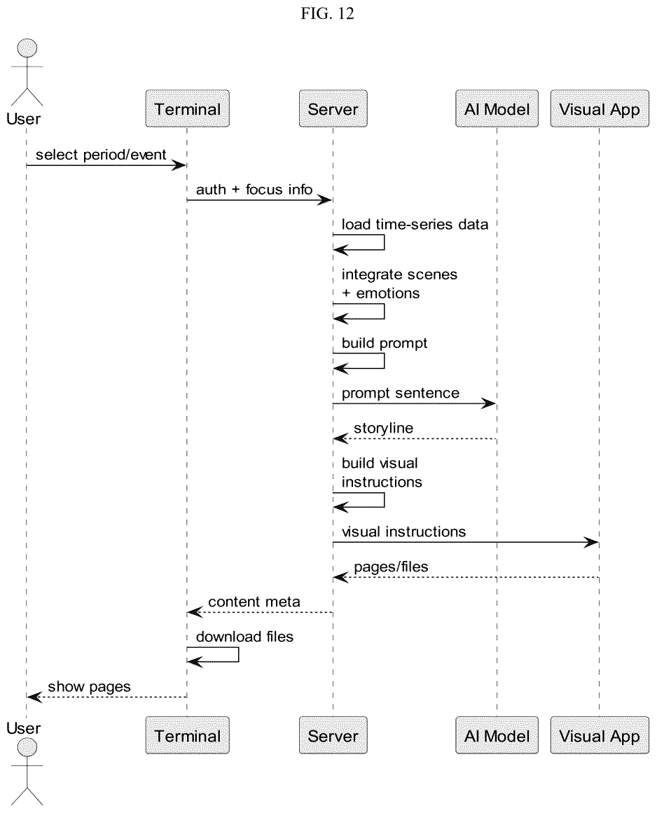

The following describes the processing flow using FIG. 12.
Step 1:

The user operates the terminal to authenticate and select a focus period or event.

The terminal displays a login screen and sends user credentials to the server as input.

The server verifies the credentials and, upon success, returns an authentication token as output.

The terminal then displays a calendar view and an event selection interface.

The user selects a date range (for example, “2022-08-01” to “2022-08-31”) or inputs a natural-language phrase (for example, “my 2022 summer vacation”).

The terminal generates focus-target specification information including the selected dates or the entered text and transmits this information, together with the authentication token, to the server as input.

The server stores the focus-target specification information in association with the user account as output for subsequent processing.
Step 2:

The server acquires and normalizes time-series information for the user.

The server receives, as input, the focus-target specification information and the user identifier derived from the authentication token.

The server queries internal storage and, if necessary, external services to retrieve past visual information (image and video metadata and references), location information (position logs), record information (diary and memo text), and schedule information (calendar records) belonging to the user.

The server filters the retrieved items according to the specified period or, when only natural-language focus is provided, according to an initial broad time range inferred from existing indices.

The server converts timestamps of all items into a unified temporal format and time zone and assigns each item to a canonical schema including fields such as timestamp, type, and reference pointer.

The server outputs normalized time-series information as a collection of structured records ordered by time.
Step 3:

The server integrates time-series information into scene candidates.

The server receives, as input, the normalized time-series information.

The server applies a temporal-spatial grouping algorithm: the server sorts items by timestamp, computes time differences between adjacent items, and clusters items into scene candidates when the time difference is below a temporal threshold and the spatial distance (derived from location information) is below a spatial threshold.

The server calls a geospatial function to convert coordinates into place names and place types and assigns this place information to each scene candidate.

The server associates visual information, record information, and schedule information with each scene candidate based on temporal overlap and, if available, explicit event identifiers.

The server outputs an integration result containing a list of scene candidates, each with linked media references and contextual attributes.
Step 4:

The server infers emotion information and refines scene information.

The server receives, as input, the integration result including scene candidates and associated record information.

The server extracts text from record information for each scene and applies a text preprocessing routine, including tokenization, normalization, and removal of stop words.

The server feeds token sequences into an emotion classification network, implemented for example as a transformer encoder with a classification head, and computes a probability distribution over emotion classes for each scene.

The server selects the emotion class with maximum probability and assigns this as emotion information to the scene, along with the probability value as an intensity measure.

The server optionally adjusts scene boundaries or merges or splits scenes when emotion intensity patterns indicate abrupt changes.

The server outputs narrative structure information including, for each scene, scene information, place information, event information summarized from record and schedule information, and emotion information.
Step 5:

The server constructs a prompt sentence for a generative AI model.

The server receives, as input, the narrative structure information and the focus-target specification information.

The server selects a subset of scenes based on relevance scores computed from factors such as emotion intensity, event type, and user-specified focus keywords.

The server extracts, for each selected scene, representative sentences from diaries, summarized event descriptions, and place names.

The server fills a prompt template with a period description, a list of visited locations, diary highlights, schedule summaries, and explicit instructions about desired output format.

The server concatenates the filled segments into a natural-language prompt sentence.

For example, the server generates the following prompt sentence as output:
“The user's target period is from Aug. 1, 2022 to Aug. 31, 2022.”

Movement logs show visits to: a central railway station (August 2-3), a historical temple district (August 10-12), and an urban waterfront area hosting a fireworks festival (August 20-22).

Diary highlights include:
‘I met my university friends in the city and felt very nostalgic.’ (August 2)
‘I visited a famous temple and was impressed by the view.’ (August 11)
‘I watched a fireworks festival by the river and felt happy and relaxed.’ (August 21)

Schedule entries include: ‘Trip to the historical city’ (August 10-12) and ‘Fireworks with a friend’ (August 21).

Based on this data, please act as a story designer and generate a chronological story line describing the user's summer vacation.

Divide the story into 8-12 scenes.

For each scene, specify:
1) scene title,
2) time or date,
3) place name,
4) main characters,
5) summary of what happens, and
6) suggested visual composition for a comic panel (for example, ‘wide shot of the temple, user in the foreground’).

“Output the result in a structured format that can be parsed programmatically.”
Step 6:

The server invokes the generative AI model and obtains storyline information.

The server receives, as input, the prompt sentence.

The server tokenizes the prompt sentence using a tokenizer compatible with the generative AI model and sends the token sequence to a generative AI model endpoint.

The generative AI model, implemented as a multi-layer transformer network, performs multi-head self-attention computations over the tokens, applies feed-forward transformations with learned parameters, and outputs probability distributions over vocabulary tokens for each position.

The server decodes the model's output tokens into text that follows the requested structure, for example a sequence of scene sections with labels.

The server parses the generated text by detecting scene delimiters and field labels and converts the result into structured storyline information, including a list of scenes with titles, times, places, main characters, summaries, and visual composition descriptions.

The server outputs the structured storyline information for further use.
Step 7:

The server generates visual expression instruction information from the storyline information.

The server receives, as input, the structured storyline information.

The server applies a layout planning algorithm that maps scenes to pages and panels; for example, the server determines the number of panels per page based on the number of scenes and the relative importance scores of scenes.

The server creates page information records, each containing a page index and layout configuration, and creates panel information records specifying coordinates, sizes, and z-order for each panel.

The server derives background information from place information and visual composition descriptions, such as “night skyline over river” or “temple courtyard overview,” and assigns these to corresponding panels.

The server generates element information describing character placeholders, key objects, and speech or narration elements, and generates text information derived from scene summaries and suggested narration or dialogue.

The server bundles page information, panel information, background information, element information, and text information into visual expression instruction information as output.
Step 8:

The server controls a visual expression generation application to render visual content.

The server receives, as input, the visual expression instruction information.

The server establishes a control channel to a visual expression generation application executing on a graphical workstation or within a container environment.

The server sends commands and structured parameters to create a new visual document, allocate pages, and define panel frames according to the panel information.

The visual expression generation application interprets the commands and creates corresponding graphical layers and objects in memory.

The server instructs the application to draw or compose background visuals according to background information, to place character and object elements according to element information, and to render narration and dialogue text according to text information.

The visual expression generation application rasterizes each page into image data and optionally assembles pages into a multi-page document file.

The server receives references to the generated files and stores the files in a storage service as output.
Step 9:

The server delivers visual content metadata to the terminal.

The server receives, as input, identifiers and storage locations of the generated visual content.

The server creates metadata records including file locations, thumbnail references, page counts, and story titles.

The server sends a response message containing the metadata to the terminal.

The terminal receives the metadata and displays a list of available visual contents and thumbnails to the user.

The terminal, based on the metadata, prepares download requests for selected visual content files.
Step 10:

The terminal retrieves and displays the generated visual content to the user.

The terminal receives, as input, the visual content metadata.

The terminal downloads image data or multi-page document data from the storage service using the provided locations.

The terminal decodes the downloaded data and stores temporary copies in local storage to enable smooth navigation.

The terminal renders a viewer interface that arranges pages in sequence and supports user interactions such as swiping, zooming, and page selection.

The user views the visual content on the display, and the terminal outputs the displayed pages and user interaction events as the final observable behavior of the system.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional content generation systems that utilize machine learning models typically treat user input text as a single, undifferentiated prompt and directly pass that prompt to a generative model to obtain a story or an image. Such systems suffer from several technical limitations. First, they lack a structured analysis pipeline that decomposes natural language input, sensor-based information, and historical data into machine-usable components (such as events, actors, places, times, and emotions). As a result, these systems cannot reliably control narrative structure, emotional tone, or visual layout, and tend to produce outputs that are inconsistent with the user's intent or difficult to map to multi-page visual content.

Second, existing systems generally do not employ a feedback-informed prompt construction mechanism that programmatically synthesizes prompt sentences from structured data and previously generated story lines. Without such an intermediate representation and prompt orchestration, the generative model is used as a “black box,” which leads to unstable results, redundant scenes, and difficulty in enforcing constraints such as the number of scenes, page structure, or emphasis on a specific event. This limits the ability of the computer system to deterministically and repeatably generate story lines and associated visual expressions in response to natural language requests.

Third, many systems that generate visuals from text do not convert story elements into explicit visual description data and layout data that can be consumed by drawing software or image generation models in a systematic way. They typically rely on manual human intervention to design page layouts, character poses, backgrounds, and panel compositions. This manual dependence prevents full end-to-end automation and reduces the throughput and scalability of the overall computer system. In particular, conventional architectures do not provide a machine-implemented pipeline that transforms high-level narrative representations into page-and panel-level visual specifications and then into actual multi-page visual content. Fourth, known systems generally do not integrate fine-grained emotion analysis across both user input and generative model output to dynamically adjust story lines and visual description data. Without automated, scene-level emotional calibration, the system cannot adequately control the atmosphere, composition, or page allocation of the generated visual content. This leads to a mismatch between the emotional intent embedded in the user's natural language request and the emotional expression in the generated visual output, reducing the effectiveness and usability of the underlying computer technology.

Accordingly, there is a need for improved computer-implemented techniques that enhance how a processor processes natural language input, past visual and contextual information, and generative model output to generate structured story lines and visual expressions. In particular, there is a need for a system architecture and processing pipeline that: (i) transforms heterogeneous input data into structured representations; (ii) constructs and refines prompt sentences for a generative AI model in a programmatic manner; (iii) converts story lines into detailed visual description data and layout data suitable for automatic rendering; and (iv) uses emotion analysis to dynamically adjust narrative and visual parameters. Such improvements aim to enhance the determinism, controllability, scalability, and computational efficiency of content generation on computer systems.

The specific processing by the specific processing unit 290 of the data processing device 12 in Example 2 is realized by the following means.

The present invention provides a server comprising a processor configured to receive, as input information, request information in natural language transmitted from a user terminal and additional information including past visual information, position information, record information, and schedule information; normalize the input information; perform language detection and machine translation as needed; and generate analysis text data; a processor further configured to perform natural language processing including morphological analysis, part-of-speech tagging, named entity extraction, and emotion analysis on the analysis text data to generate structured data including an event, an actor, a place, a time, an emotion, and a user preference, and to generate a story line describing a life of an individual based on the structured data; a processor further configured to automatically generate a prompt sentence for input to a generative AI model based on the structured data and the story line in accordance with a template or rule, to input the prompt sentence to the generative AI model to cause the generative AI model to generate or supplement a story line, and to determine an output result of the generative AI model as a finalized story line; a processor further configured to divide the finalized story line into scenes, to generate visual description data for each scene including a background, an appearance, a posture, an expression, a placement, a main action, a spoken line, and an emotion of an actor, and to convert the visual description data into layout data associated with pages and panels; and a processor further configured to input the layout data to a drawing software program or an image generation model, to cause automatic generation of a visual expression including a plurality of pages in accordance with the layout data, to output the generated visual expression as an image file or a document file, and to store and provide the visual expression in a format deliverable to the user terminal. This enables the computer system to implement a structured, multi-stage content generation pipeline that programmatically converts heterogeneous input data into controlled prompt sentences, refined story lines, and page-structured visual expressions, thereby improving the determinism, controllability, and efficiency of generative AI-based story and visual content generation.

The term “processor” refers to a hardware or virtual computation unit, such as a central processing unit, a graphics processing unit, or a combination thereof, that executes instructions to perform the functions described herein.

The term “user terminal” refers to an electronic device operated by a user, including but not limited to a mobile device, a tablet device, a desktop device, or a browser-based client, that transmits request information in natural language and receives generated visual expressions.

The term “input information” refers to data received by the processor from the user terminal or from one or more data sources, including request information in natural language and additional information such as past visual information, position information, record information, and schedule information.

The term “past visual information” refers to previously captured or generated visual data, including but not limited to still images, moving images, or graphic representations, associated with an individual or an event.

The term “position information” refers to data representing a geographic location or spatial position, which may include coordinates, place identifiers, or other location-related attributes.

The term “record information” refers to logged or stored data reflecting user behavior, activities, or system events, including but not limited to activity logs, usage histories, or sensor-derived records.

The term “schedule information” refers to temporal data indicating planned or past events, appointments, or time-based activities associated with a user or an individual.

The term “normalize” refers to processing operations that convert input information into a unified or standardized format, including character encoding normalization, whitespace removal, and other preprocessing suitable for subsequent analysis.

The term “analysis text data” refers to textual data that has been generated from input information after normalization, language detection, and optional translation, and that is used as a basis for natural language processing.

The term “language detection” refers to a computational process that identifies the natural language of input text, such as determining whether the text is written in one language or another.

The term “machine translation” refers to an automated process that converts text expressed in a first language into a second language using a translation model executed by a computing device.

The term “natural language processing” refers to a set of computational techniques for analyzing and interpreting human language, including, but not limited to, morphological analysis, part-of-speech tagging, named entity extraction, and emotion analysis.

The term “morphological analysis” refers to a processing operation that segments text into minimal meaningful units, such as words or morphemes, and assigns grammatical or lexical information to the segments.

The term “part-of-speech tagging” refers to assigning grammatical categories, such as nouns, verbs, adjectives, or adverbs, to words or tokens in text.

The term “named entity extraction” refers to identifying and classifying spans of text that correspond to entities such as persons, locations, organizations, events, or temporal expressions.

The term “emotion analysis” refers to a computational process that estimates one or more emotional attributes, such as happiness, sadness, excitement, or nostalgia, from textual data or other data associated with a scene or user input.

The term “structured data” refers to data organized into explicitly defined fields or attributes, such as an event, an actor, a place, a time, an emotion, and a user preference, so that each item of data is machine-readable and individually accessible.

The term “event” refers to an occurrence or situation in time that is to be represented in a story line, such as a ceremony, a meeting, or a daily activity.

The term “actor” refers to a subject, such as a person, character, or entity, that participates in an event described in the story line.

The term “place” refers to a location or setting where an event occurs, which may include physical environments, virtual environments, or abstract locations.

The term “time” refers to temporal information associated with an event, including specific dates, times of day, durations, or relative temporal relations.

The term “emotion” refers to an affective state or sentiment, such as joy, sadness, tension, or calmness, associated with a user, an actor, a scene, or a story line.

The term “user preference” refers to a condition or constraint specified by a user, explicitly or implicitly, such as a desired tone, length, focus, or structural property of a story line or visual expression.

The term “story line” refers to an ordered sequence of scenes, events, or narrative units describing a life of an individual or a series of occurrences, including descriptions of settings, actions, and emotional developments.

The term “generative AI model” refers to a machine-learned model configured to generate output data, such as text or images, based on input data, including but not limited to models that generate or supplement a story line in response to a prompt sentence.

The term “prompt sentence” refers to an instruction or query expressed as textual data and provided as input to a generative AI model to cause the generative AI model to generate or modify output data such as a story line.

The term “finalized story line” refers to a story line that has been generated or supplemented by a generative AI model and has been determined by the processor as a definitive version to be used for subsequent processing.

The term “scene” refers to a unit of the story line representing a cohesive segment of narrative content, including at least one event, setting, and set of actions or dialogues.

The term “visual description data” refers to data describing visual aspects of a scene, including at least a background, an appearance, a posture, an expression, a placement, a main action, a spoken line, and an emotion of an actor.

The term “background” refers to visual elements representing the environment or setting of a scene, such as a room, a building, or an outdoor landscape.

The term “appearance” refers to visual attributes of an actor, including but not limited to clothing, physical features, and accessories.

The term “posture” refers to the body position or stance of an actor within a scene.

The term “expression” refers to a visual representation of the emotional state of an actor, such as a smiling face, a crying face, or a neutral face.

The term “placement” refers to spatial positioning of actors and objects within a visual frame, page, or panel.

The term “main action” refers to a principal movement, gesture, or interaction performed by an actor within a scene.

The term “spoken line” refers to text representing speech or dialogue of an actor, which is to be rendered as a speech balloon or caption in a visual expression.

The term “layout data” refers to data specifying an arrangement of visual elements, including pages and panels, and their associated visual description data, for rendering a visual expression.

The term “page” refers to a single frame or canvas unit within a multi-page visual expression, such as one page of a comic, illustration set, or document.

The term “panel” refers to a sub-region of a page that contains visual content representing a subset of a scene or a particular moment within a scene.

The term “drawing software program” refers to application software executed by a computing device that can generate or edit visual content based on layout data and visual description data.

The term “image generation model” refers to a machine-learned model configured to generate image data based on textual or structured input data such as layout data and visual description data.

The term “visual expression” refers to one or more visual representations, including multi-page content, that depict a story line, and that are generated as image files, document files, or other visual content.

The term “image file” refers to a digital file storing visual information in a raster or vector format, such as a bitmap image, suitable for display on a user terminal.

The term “document file” refers to a digital file that can contain one or more pages of visual content, optionally with text, suitable for viewing or printing.

The term “deliverable format” refers to a data format and packaging suitable for transmission to and rendering on a user terminal, including consideration of encoding, compression, and access method.

The term “user emotion tendency” refers to an estimated pattern or profile of emotional preference or response of a user, determined from user input, historical data, or interaction history.

The term “emotion estimation for each scene” refers to an assessment of the dominant or intended emotion associated with a particular scene within a story line, derived from textual or model-generated data.

The term “atmosphere of the visual expression” refers to an overall emotional or stylistic impression conveyed by the visual content, including tone, color scheme, and intensity of depicted emotions.

The term “composition of the visual expression” refers to the structural arrangement of visual elements, including the organization of scenes into pages and panels, and the spatial balance within each panel.

In one embodiment of the present invention, a server cooperates with one or more terminals operated by users to generate structured story lines and corresponding multi-page visual expressions based on natural language input and additional contextual information. The server includes at least one processor, a main memory, a non-volatile storage device, a network interface, and, in some embodiments, a graphics processing unit. The server executes an operating system such as a general-purpose server operating system and executes application software implementing the modules described below. The server may further execute natural language processing libraries, a generative AI model client library, and an automation interface for a drawing software program.

The terminal includes a processor, a memory, a display, an input interface such as a touch panel or keyboard, and a communication interface. The terminal executes an operating system such as a mobile device operating system or a desktop operating system and executes a client application or a browser that communicates with the server. The terminal displays a user interface for inputting natural language text and for viewing generated visual expressions.

The user uses the terminal to input a natural language request describing an event and desired characteristics of a story. The terminal provides a text input area and optionally selection controls for preferences such as desired length, emotional tone, or focus. The terminal converts the user's input into digital text data and transmits the text data and optional metadata to the server via a communication protocol such as HTTPS.

The server receives the natural language text and additional contextual information as input information. The server may receive, for example, past visual information in the form of stored image files, position information obtained from a location sensor of the terminal, record information such as activity logs, and schedule information such as calendar entries. The server stores the received data in a structured database or key-value store, associating each item with a user identifier and a request identifier.

The server normalizes the input information by converting character encodings to a unified encoding, removing extraneous control characters, and standardizing date, time, and location formats into canonical representations. The server performs language detection using a statistical or neural classifier that takes as features character n-grams, word-level statistics, and optionally byte-level encodings. The server, when the detected language is different from an internal processing language, performs machine translation using a translation model. The translation model may be a neural sequence-to-sequence model with an encoder-decoder architecture and attention mechanism, trained on sentence pairs, and executed as a service. The server outputs analysis text data in the internal processing language.

The server performs natural language processing on the analysis text data. The server loads a language model and tokenization rules and segments the text into tokens. The server runs part-of-speech tagging using a recurrent neural network, transformer-based model, or a conditional random field model trained on annotated corpora. The server extracts named entities using a sequence labeling model that outputs labels for person, place, organization, event, and temporal expressions. The server performs emotion analysis using a classifier that maps text segments into an emotion category space, for example “joy,” “sadness,” “surprise,” “fear,” or “nostalgia,” using features derived from contextual word embeddings.

The server aggregates these analysis results into structured data. The server constructs data structures that include fields such as event, actor, place, time, emotion, and user preference. For example, the server may interpret “graduation day” as an event, “teacher” and “best friend” as actors, and “school auditorium” as a place. The server stores these fields in a structured representation such as a tree or graph, where nodes represent narrative elements and edges represent relations such as temporal order or causal links. This structured representation allows the server to perform subsequent computations on discrete machine-readable elements rather than on raw text.

The server generates an initial story line based on the structured data. The server uses rule-based logic and templates to define a minimal sequence of scenes that covers the identified event and the associated actors and emotions. For instance, when the structured data indicates a graduation event and a farewell to a best friend, the server constructs a sequence including “preparation,” “ceremony,” “social interactions,” “farewell,” and “reflection.” The server assigns each scene an approximate time, location, and emotional intensity, and stores the result as a scene list with associated attributes. This operation ensures that the generative AI model receives a structured context, thereby improving coherence and technical controllability compared to ad hoc prompts.

The server constructs a prompt sentence for a generative AI model using the structured data and the initial story line. The server employs a template-based prompt construction engine that inserts extracted values into parameterized text. For example, the server may generate a prompt sentence such as:

“The user wants a touching story line about their graduation day. Focus especially on the farewell scene with the user's best friend. Create a scene-by-scene story line suitable for a manga, including settings, character actions, emotions, and short dialogues. Generate 8 scenes that can be mapped to 8 manga pages, and describe each scene in 3-5 sentences.”The server may alternatively generate another example prompt sentence such as:
“Create a detailed story line suitable for a 6-page comic. The main event is the user's junior high school graduation. Focus on the last conversation with the user's homeroom teacher. For each of 6 scenes, describe the setting, characters, actions, emotions, and short dialogues. Emphasize a touching and respectful tone.”

The server generates such prompt sentences algorithmically by combining slots in the template with values from the structured data and the initial scene list, rather than echoing the user's input verbatim. This structured prompt construction improves reproducibility and reduces variance in the generative AI model outputs.

The server provides the prompt sentence to a generative AI model. In one embodiment, the generative AI model is a large-scale neural network with a transformer architecture trained on text data to perform next-token prediction. The generative AI model includes multiple layers of self-attention blocks and feed-forward networks, with learned parameters stored in model weights. The server communicates with the model via an application programming interface, transmitting the prompt sentence, maximum output length, and a sampling temperature that controls randomness. The server receives a generated story line as output.

The server parses the generated story line and integrates it with the initial story line. The server uses regular expressions or structured output conventions (such as explicit labels “Scene 1,” “Scene 2,” etc.) to segment the generated text into scene units. The server compares each generated scene with the initial scene list and aligns corresponding scenes using similarity metrics such as cosine similarity of sentence embeddings. The server resolves conflicts by selecting or merging segments according to predetermined rules, such as preferring scenes that include required actors or required emotional peaks. The resulting merged output is stored as a finalized story line.

The server divides the finalized story line into scenes and generates visual description data for each scene. The server converts textual descriptions of locations into background categories such as “indoor auditorium,” “classroom,” or “rooftop,” and further into parameter sets including camera angle, approximate lighting, and density of background objects. The server converts descriptions of actors into character specifications including body type, apparel category, color scheme, and distinguishing features. The server converts textual cues of emotion into facial expression codes and body posture codes. For example, the server may map “smiling with tears” to an expression code combining mouth shape and eye shape parameters, and “hugging tightly” to a posture code indicating arm position and body orientation.

The server stores this visual description data as structured records, associating each scene with a list of actors, background parameters, and action descriptors. The server then converts the description data into layout data specifying a mapping from scenes to pages and panels. The server uses a page layout algorithm that allocates more panel area to scenes with high emotional intensity or dense dialogue, and fewer panels to transitional scenes. The server encodes panel boundaries, relative positions, and reading order in a data structure. This algorithmic layout decision is non-trivial and is based on computed metrics such as scene importance and text length, thus providing a technical effect on how information is visualized and reducing manual layout design effort.

The server delivers the layout data to a drawing software program or an image generation model. In one embodiment, the server controls a drawing software program installed on a graphics-capable workstation. The server uses a scripting interface to create documents, set page sizes, create panels, place character layers, and import background assets according to the layout data. In another embodiment, the server provides text descriptions per panel to an image generation model, such as a diffusion-based image generator, that outputs raster images based on the visual description data. The server passes conditioning vectors representing background, actors, and style as input to the image generation model. The image generation model is, for example, a convolutional or transformer-based neural network with a latent diffusion process trained on paired text-image data.

The server combines generated panel images into pages according to the layout data. The server overlays speech balloons and captions at positions calculated from the panel geometry and associated spoken lines. The server then exports each page as an image file or as part of a multi-page document file. The server stores metadata for each generated page, including scene identifiers, time stamps, and file locations, in a database to facilitate later retrieval and version control.

The server uses emotion analysis results to adjust the story line and visual description data. For example, when emotion analysis indicates that a particular scene lacks sufficient emotional intensity relative to the user's expressed preference, the server may invoke additional prompt sentences to refine or extend that scene. The server may generate a refinement prompt sentence such as:
“Revise Scene 5 of the graduation story to heighten the emotional impact of the farewell with the best friend. Add more internal monologue and physical gestures that show conflicting feelings of joy and sadness.”

The server submits this refinement prompt sentence and the current scene content to the generative AI model, receives a revised scene, and updates the finalized story line and corresponding visual description data. This feedback loop allows the server to systematically converge toward a story line and visual expression that match quantitative emotion profiles derived from data, rather than relying on a single-pass generation.

The server improves computational efficiency and data management through this multi-stage architecture. By first reducing free-form text into structured data, the server limits the size of the prompt sentence and focuses the generative AI model on relevant elements, which reduces unnecessary tokens and network traffic. The server stores intermediate structured representations, allowing reuse in subsequent requests and enabling incremental updates of specific scenes without regenerating the entire story. The server thus reduces computation costs and latency, achieving faster response times and more consistent outputs than systems that repeatedly send large, unstructured prompts.

The server improves technical precision and error rates by applying rule-based constraints and structured alignment around the generative AI model. The server does not rely solely on the model's unconstrained generation; instead, the server enforces that required actors, events, and time sequences appear in the final story line. This constraint-based orchestration reduces logical inconsistencies and omissions typical of unconstrained generative models. The causal relationship between structured data, constrained prompt construction, and post-generation alignment yields a measurable improvement in narrative consistency and reduces the need for manual correction.

The server internally executes the generative AI model using a neural network architecture that has been trained with supervised learning. The server stores model parameters as weight matrices in memory. During training, the server obviates manual story design by using a loss function that measures cross-entropy between predicted tokens and reference tokens and updates weights through backpropagation and gradient descent. The server may perform data augmentation during training by paraphrasing sentences, varying narrative length, and introducing alternative emotional framing, thereby enhancing model robustness to variations in user input. The server thereby uses a specific machine learning architecture and training method, rather than an undefined “AI,” and the resulting trained model performs specific computations over vectors and tensors.

The server implements the described modules as distinct software components, such as an input normalization module, a natural language analysis module, a structured representation module, a prompt generation module, a generative model interface module, a story alignment module, a visual description generation module, a layout engine, and a rendering control module. Each module communicates through defined data structures stored in memory. This modular data flow enables independent optimization of each stage, such as caching results from the natural language analysis module or parallelizing rendering operations. As a result, the server can scale to many concurrent user requests without linear increases in latency.

The terminal receives the generated visual expression from the server as image files or document files. The terminal stores the received files in a local cache and progressively loads pages as the user scrolls. The terminal displays panels with appropriate resolution and may offer interaction functions such as zooming and page navigation. The user thereby experiences a customized visual representation of the story that was automatically generated.

In alternative embodiments, the server adjusts the degree of automation. The server may, for example, generate only the story line and visual description data, and transmit the layout data to a client-side application that performs the final rendering using a local drawing library. The server may alternatively generate only a textual story line and send structured scene descriptors that third-party applications can process. In another variation, the server may use different generative AI models for story generation and visual concept generation, such as a text-only model for narrative structure and an image-conditioned model for character design. The system described above does not merely automate a human creative process. The server applies specific computational techniques and data structures to improve how computing devices process heterogeneous narrative input and generate multi-page visual content. The use of structured intermediate representations, algorithmic prompt sentence construction, constrained generative output alignment, and algorithmic layout optimization yields technical effects such as improved processing speed, reduced bandwidth consumption, increased narrative consistency, and more reliable mapping of narrative elements to visual structures. The combination of these mechanisms constitutes an improvement to computer-based content generation technology itself, enabling operations that are not practical with manual human-only methods or with simple direct prompting of generative AI models.

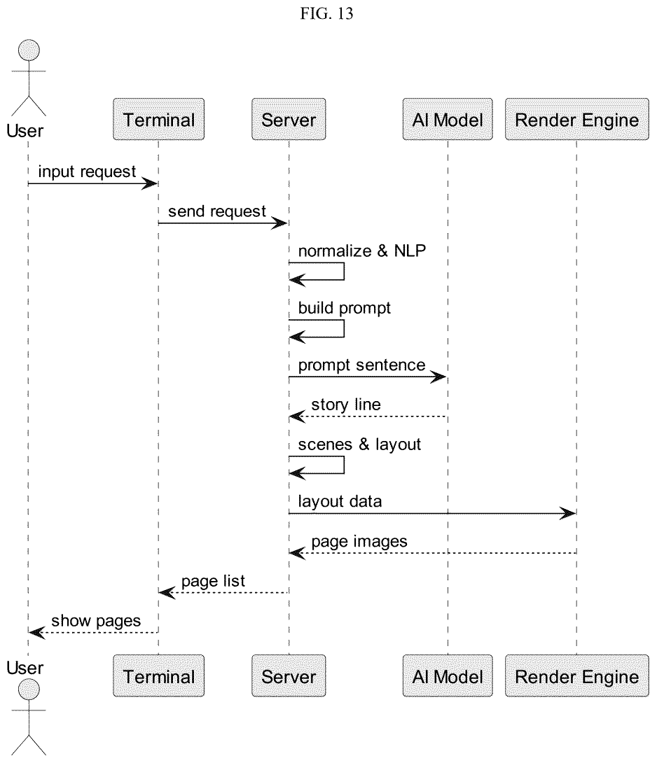

The following describes the processing flow using FIG. 13.
Step 1:

The user operates the terminal to launch a client application or web browser and opens a content generation screen.

The terminal displays an input field and configuration controls for specifying an event to be depicted, desired emotional tone, and optional constraints such as number of pages.

Input: The user enters a natural language request, for example, “Please create a touching manga about my graduation day, focusing on saying goodbye to my best friend,” and selects options such as “8 pages.”

The terminal converts the user's keystrokes or touch input into a text string and packs the text string and option values into a request object.

Output: The terminal outputs a structured request message including at least the natural language text and the selected options and transmits this message to the server over a network connection using a protocol such as HTTPS.
Step 2:

The server receives the structured request message from the terminal through a network interface.

Input: The server takes as input the raw HTTP request containing a payload with the user's natural language request and option values.

The server parses HTTP headers, decodes the payload, and extracts the text field and supplementary parameters such as desired page count and emphasis flags.

The server assigns a unique request identifier, associates the request with a user identifier, and stores a copy of the raw request in a request log.

Output: The server outputs a normalized internal request record containing the user identifier, request identifier, natural language text, and normalized option values.
Step 3:

The server performs text normalization and language detection on the natural language text.

Input: The server takes as input the natural language text and encoding metadata from the internal request record.

The server converts the text to a unified character encoding, removes control characters, trims whitespace, and standardizes punctuation.

The server applies a language detection algorithm that computes character n-gram frequencies and compares them with language profiles to determine the primary language.

If the detected language differs from an internal processing language, the server invokes a machine translation component to translate the text into the internal language, generating a translated string.

Output: The server outputs analysis text data, which is a clean, single-language text string along with detected language information and translation status.
Step 4:

The server performs natural language processing to extract structural elements from the analysis text data.

Input: The server takes as input the analysis text data produced in Step 3.

The server tokenizes the text into word tokens and punctuation using a tokenizer; then, the server performs part-of-speech tagging using a trained model to assign grammatical categories to each token.

The server executes named entity recognition to identify mentions of events, persons, locations, organizations, and temporal expressions, such as “graduation day,” “best friend,” or “school.”

The server performs dependency parsing or semantic role labeling to identify relations such as who is doing what to whom, and at what time and place.

The server applies emotion analysis by feeding the sentence-level or phrase-level embeddings into an emotion classifier that outputs one or more emotion labels and confidence scores.

The server aggregates these results into structured data, for example fields for event, actor, place, time, emotion, and user preference, using rules and mapping tables.

Output: The server outputs a structured data object that encodes the extracted elements and their relationships, ready for story construction.
Step 5:

The server constructs an initial story structure and scene list from the structured data.

Input: The server takes as input the structured data describing events, actors, and emotions.

The server uses a rule-based engine that maps high-level events like “graduation” to canonical story phases such as “preparation,” “ceremony,” “social interaction,” “farewell,” and “reflection.”

The server orders these phases according to typical temporal progression and checks whether constraints such as “focus on farewell” require certain phases to be expanded or emphasized.

The server allocates an approximate number of scenes to each phase based on the requested page count and the relative importance scores derived from user preferences and emotion intensity.

The server creates a scene list data structure, where each scene entry includes fields for phase type, intended location, involved actors, intended emotion, and an importance score.

Output: The server outputs an initial story structure object containing an ordered list of scene descriptors with assigned roles and parameters.
Step 6:

The server generates a prompt sentence for a generative AI model using the initial story structure and the structured data.

Input: The server takes as input the structured data and the initial story structure object from Step 5.

The server selects a template for a prompt sentence that specifies the number of scenes, required focus points, emotional tone, and content type (e.g., “suitable for a manga”).

The server fills template slots using values from the structured data and scene list, such as event name, key actors, target page count, and desired tone.

The server may produce, for example, the following prompt sentence:
“The user wants a touching story line about their graduation day. Focus especially on the farewell scene with the user's best friend. Create a scene-by-scene story line suitable for a manga, including settings, character actions, emotions, and short dialogues. Generate 8 scenes that can be mapped to 8 manga pages, and describe each scene in 3-5 sentences.”The server stores the generated prompt sentence together with the request identifier for traceability.

Output: The server outputs a finalized prompt sentence string ready to be supplied to the generative AI model.
Step 7:

The server queries the generative AI model with the prompt sentence and obtains a generated story line.

Input: The server takes as input the prompt sentence generated in Step 6.

The server formats the prompt sentence into a request payload and sends it to the generative AI model interface, specifying parameters such as maximum token length and sampling temperature.

The generative AI model, implemented as a trained transformer-based neural network, processes the prompt sentence and generates a sequence of tokens forming a detailed story line.

The server receives the generated text, verifies that the output conforms to expected structure (for example, presence of scene markers such as “Scene 1,” “Scene 2”), and truncates or repairs minor formatting errors if necessary.

Output: The server outputs a raw generated story line text that reflects the generative AI model's response to the prompt sentence.
Step 8:

The server parses and reconciles the raw generated story line with the initial story structure.

Input: The server takes as input the raw generated story line text and the initial story structure object.

The server splits the generated text into scene segments by detecting scene labels or separators and associates segment indices with scene identifiers.

The server computes similarity metrics between each generated segment and each planned scene descriptor by comparing keyword overlap, actor mentions, and emotion labels obtained through a secondary NLP pass on the generated text.

The server aligns generated segments to planned scenes using an optimization algorithm that maximizes total similarity while preserving temporal order.

The server merges aligned data by incorporating generated narrative content, actions, and dialogues into the corresponding scene descriptors and resolves conflicts using priority rules (for example, ensuring that key events are present).

Output: The server outputs a finalized story line data structure, where each scene includes coherent narrative text, associated actors, locations, and target emotions aligned with user intent.
Step 9:

The server generates visual description data for each scene from the finalized story line.

Input: The server takes as input the finalized story line data structure.

The server analyzes each scene's narrative text to extract explicit and implicit visual cues, such as “in the school auditorium,” “classmates gathered around,” “teacher handing a diploma,” or “tears in the eyes.”

The server maps these cues to predefined visual parameter sets, including background type, camera angle, lighting condition, and density of background elements.

The server identifies each actor's role and emotional state per scene and converts these into appearance parameters (clothing style, color scheme) and expression/pose parameters (facial expression codes, body posture codes).

The server assembles this information into visual description records that, for each scene, specify a background configuration, a list of character configurations, key actions, and text for spoken lines or captions.

Output: The server outputs a collection of visual description data objects corresponding to the scenes of the story.
Step 10:

The server converts visual description data into layout data specifying pages and panels.

Input: The server takes as input the visual description data objects and the requested page count or scene count.

The server calculates scene importance scores based on narrative significance and emotion intensity and assigns more panel space to high-importance scenes and less to low-importance scenes.

The server decides how many scenes to place on each page and how many panels to allocate per scene, targeting readability and visual balance.

The server computes panel geometries (positions and sizes) on each page using a layout algorithm that divides the page canvas into rectangular regions and respects reading order conventions.

The server associates each panel with a subset of visual description data (for example, one or two key moments in a scene) and calculates text balloon positions based on available panel area and length of spoken lines.

Output: The server outputs layout data, which is a structured specification of pages, panels, and assigned visual and textual content for each panel.
Step 11:

The server generates visual expression files using a drawing software program or an image generation model based on the layout data.

Input: The server takes as input the layout data produced in Step 10.

The server, when using a drawing software program, instantiates documents for each page, creates panel frames according to panel geometries, and populates each panel with background layers and character layers derived from the visual description data.

The server, when using an image generation model, formulates per-panel textual prompts or vector encodings from the visual description data and submits them to the model to obtain raster images.

The server composes these images into the predefined panel frames, overlays speech balloons with the spoken lines, and adjusts font size and balloon shape to fit within allocated areas.

The server exports each completed page as an image file (for example, PNG) or as part of a multi-page document file (for example, PDF) and stores the files in a storage system.

Output: The server outputs a set of generated visual expression files, each representing a page of the story, together with metadata linking them to the user and request.
Step 12:

The server prepares response information and delivers the generated visual expressions to the terminal.

Input: The server takes as input file locations and metadata of the generated visual expression files.

The server generates access paths or URLs for each page file and constructs a response object containing ordered references to the pages along with page numbers and optional summary information.

The server transmits the response object to the terminal over the network using a protocol such as HTTPS, ensuring that identifiers and access tokens are correctly associated with the requesting user.

Output: The server outputs a response message to the terminal that enables the terminal to retrieve and display the generated pages.
Step 13:

The terminal receives and displays the generated visual expressions to the user.

Input: The terminal takes as input the response message from the server that contains page references or URLs.

The terminal parses the response, requests each page file from the server or storage location, and downloads the visual expression data.

The terminal decodes the image or document files and renders each page on the display in reading order, possibly providing thumbnail previews and navigation controls.

The terminal allows the user to scroll, swipe, or tap to move between pages and adjust zoom levels, thereby presenting the story as a multi-page visual expression generated based on the user's original natural language request.

Output: The terminal outputs the visual representation on the display, and the user perceives and interacts with the completed story.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional content generation systems that rely on generative AI models suffer from several technical limitations at the level of computer processing and system architecture. First, conventional systems typically accept only simple textual prompts and do not structurally integrate heterogeneous user data such as past visual information, location information, activity records, and schedule information. As a result, the processor cannot form a rich, time-series context about a particular individual's life, and the generative AI model is forced to operate on under-specified prompts, which leads to unstable output quality, inconsistent narrative structure, and increased need for manual trial-and-error prompt engineering by the user.

Second, conventional systems generally treat the generation of textual storylines and the generation of images as independent processes. They do not implement a systematic intermediate representation that decomposes a target work into page-level or scene-level units, and they do not automatically derive, for each unit, a structured image prompt sentence including actors, background environments, objects, and emotional expressions. This lack of a page-or scene-aware pipeline causes inefficiencies in computation, redundant calls to generative AI models, and difficulty in aligning narrative structure with the final visual layout. In particular, when a fixed page count is desired, existing systems often fail to guarantee that the generated storyline and images accurately conform to that page count.

Third, conventional systems provide only limited support for dynamic personalization based on user emotion. Even if sentiment analysis is sometimes applied to user text, the result is rarely integrated deeply into the machine-side pipeline. The processor typically does not use an emotion analysis unit to quantitatively estimate a user's emotional state from multimodal inputs (facial information, voice information, and text information), and does not propagate that estimated emotion state into the construction of prompt sentences or the adjustment of the generated storyline. Consequently, it is technically difficult for the system to control, in a consistent and repeatable manner, the tone, scene structure, and emotional intensity of content generated by the underlying models.

Fourth, conventional architectures lack fine-grained, computationally efficient mechanisms for partial regeneration. When a user wishes to modify only a specific page or scene of a visual work, existing systems generally require regeneration of the entire storyline or entire image set. This leads to unnecessary processor load, redundant data transfer between systems, and degraded response time. From the perspective of computer technology, the absence of a page-or scene-scoped regeneration mechanism represents a suboptimal use of the generative AI model's computational resources and of network and storage resources in the overall system.

Accordingly, there is a need for a system-level improvement in how a processor orchestrates heterogeneous user data, natural language instructions, page count constraints, and emotion analysis results to generate structured prompt sentences for generative AI models, to obtain a storyline that is explicitly divided into scene units, to derive corresponding image prompt sentences, and to assemble a consistent, page-accurate visual expression. There is also a need for an architecture that supports emotion-aware adjustment of both textual and visual outputs and that allows partial regeneration of specified pages or scenes without recomputing the entire work. The present invention addresses these technical problems by restructuring and augmenting the roles of the processor, the prompt sentence generation, and the interaction with text-type and image-type generative AI models.

The specific processing by the specific processing unit 290 of the data processing device 12 in Application Example 2 is realized by the following means.

The present invention provides a server comprising a processor configured to receive, from a user terminal, a plurality of types of input information including natural language instructions, a page count designation, and past visual information, location information, activity record information, and schedule information; analyze the received natural language instructions by using a language processing unit to extract a focused event, a target page count, and emotion-related expressions; integrate the plurality of types of input information by using a data analysis unit to generate summarized life information for each user in time series; generate, on the basis of the extracted event and the target page count, the summarized life information, and the emotion-related expressions, a prompt sentence to be input to a text-type generative AI model; input the prompt sentence to the text-type generative AI model and generate a storyline that is divided into a plurality of scene units corresponding to the target page count and that reflects the event and the summarized life information; analyze the storyline for each page or for each scene and generate, for each page or each scene, visual description information including actors, background environments, objects, and emotional expressions; generate, on the basis of the visual description information, an image prompt sentence to be input to an image-type generative AI model; input the image prompt sentence to the image-type generative AI model and generate a plurality of image data items corresponding to the respective pages or scenes of the storyline; and construct, by using a layout generation unit, a visual expression having a page composition corresponding to the target page count by using the generated storyline and the plurality of image data items, and provide the visual expression to the user terminal. This enables the computer system to transform heterogeneous user data and high-level natural language instructions into a structured sequence of prompt sentences and model invocations, thereby improving the determinism, structural consistency, and computational efficiency of narrative and image generation, enforcing page-count conformity, and reducing manual trial-and-error prompt engineering on the client side.

The present invention further provides that the processor is configured to input facial information, voice information, and text information acquired from the user terminal to an emotion analysis unit to estimate an emotional state of a user; adjust at least one of tone, scene structure, and content of the prompt sentence and the storyline in accordance with the emotional state; and generate the image prompt sentence and the visual expression reflecting a result of the adjustment. This enables the server-side processing pipeline to incorporate multimodal emotion estimation directly into the generation and refinement of both textual and visual content, thereby allowing the system to programmatically control the emotional character of the generated work and to achieve more consistent personalization without requiring manual re-authoring by the user.

The present invention further provides that the processor is configured to regenerate at least a part of the prompt sentence and the image prompt sentence corresponding to a specified page or scene on the basis of a modification instruction in natural language received from the user terminal; regenerate only a storyline and image data of the specified page or scene by using the text-type generative AI model and the image-type generative AI model; and partially update the visual expression on the basis of a regeneration result. This enables fine-grained, page-or scene-specific regeneration that reduces unnecessary computation and data transfer, improves response time for user edits, and enhances the overall efficiency and scalability of the computer system implementing the generative AI workflow.

The term “user terminal” refers to an information processing device operated by a user, such as a portable information device, a stationary information device, or a wearable information device, that is configured to transmit input information to a server and to receive and display a visual expression.

The term “input information” refers to data supplied from the user terminal to the server, including at least natural language instructions, page count designations, and one or more of past visual information, location information, activity record information, and schedule information.

The term “natural language instructions” refers to character string data expressed in a human language that a user inputs to specify a requested theme, event, emotion, or generation condition, without requiring a predefined programming language format.

The term “page count designation” refers to information that indicates a desired number of pages or scenes for a visual expression to be generated, and that is used by the processor as a constraint when constructing a storyline and performing layout.

The term “past visual information” refers to image data or moving image data, such as photographs or videos, associated with a user's past experiences and usable as context for generating a storyline or visual expression.

The term “location information” refers to data representing a geographical position, such as coordinate information, region identifiers, or place names, associated with a user's past or present activities.

The term “activity record information” refers to data describing actions, events, or behaviors of a user over time, including but not limited to logs of visited places, performed activities, or recorded events.

The term “schedule information” refers to data that indicates planned or recorded time-based events for a user, such as entries in a calendar, agenda, or timetable.

The term “language processing unit” refers to a software or hardware component configured to analyze natural language instructions, to perform tasks such as tokenization, parsing, entity extraction, and detection of page counts and emotion-related expressions.

The term “data analysis unit” refers to a software or hardware component configured to process, correlate, and summarize heterogeneous input information, including past visual information, location information, activity record information, and schedule information, in order to generate time-series summarized life information.

The term “summarized life information” refers to data derived from analysis of the heterogeneous input information that represents, in a condensed time-series form, key events, places, and contexts associated with an individual user's past life activities.

The term “event” refers to a specific situation, occurrence, or topic that is to be described in a storyline, such as a celebration, a daily scene, or a particular experience designated or implied by the user.

The term “target page count” refers to a numerical value representing the number of pages or scene units that the generated storyline and visual expression are intended to occupy.

The term “emotion-related expressions” refers to words, phrases, or linguistic features in the natural language instructions that indicate a user's emotional state or desired emotional tone for the generated content, such as happiness, sadness, excitement, or nostalgia.

The term “prompt sentence” refers to a text string constructed by the processor and provided as input to a generative AI model, the text string including instructions, constraints, and contextual information that guide the model's output.

The term “text-type generative AI model” refers to an artificial intelligence model configured to generate text data, such as storylines or narrative descriptions, in response to an input prompt sentence.

The term “storyline” refers to text data representing a sequence of narrative elements, including events, characters, and actions, that define the structure of a story to be visualized, and that may be divided into page units or scene units.

The term “scene unit” refers to a discrete narrative segment within a storyline, corresponding to at least part of a page or an entire page in a visual expression, and describing a specific moment, action, or situation.

The term “visual description information” refers to structured data derived from the storyline and configured to describe, for each page or scene, at least actors, background environments, objects, and emotional expressions for use in image generation.

The term “actor” refers to an entity, such as a person, character, or creature, that appears in a scene and performs actions or expresses emotions.

The term “background environment” refers to visual elements that represent the setting of a scene, including locations, architectural structures, natural scenery, and interior spaces.

The term “object” refers to a physical item or symbolic element that appears within a scene and contributes to the visual or narrative context, such as tools, decorations, or props.

The term “emotional expressions” refers to visual features, such as facial expressions, body posture, color tone, or lighting, that convey an emotional state in a generated image.

The term “image prompt sentence” refers to a text string constructed by the processor on the basis of visual description information and provided as input to an image-type generative AI model to guide image synthesis.

The term “image-type generative AI model” refers to an artificial intelligence model configured to generate image data, such as illustrations or frames, in response to an input image prompt sentence.

The term “image data” refers to digital data representing a still image, frame, or illustration generated by the image-type generative AI model for a corresponding page or scene.

The term “layout generation unit” refers to a software or hardware component configured to arrange text and image data into a page-based or scene-based structure, thereby creating a visual expression with a specified page composition.

The term “visual expression” refers to a generated digital work that combines at least the storyline and corresponding image data, arranged into a structured layout such as a multi-page comic, illustrated story, or similar visual content.

The term “emotion analysis unit” refers to a software or hardware component configured to process one or more of facial information, voice information, and text information to estimate an emotional state of a user.

The term “emotional state” refers to information that represents an estimated emotion of a user, including at least an emotion category and optionally an intensity, derived from analysis of multimodal input.

The term “tone” refers to a qualitative characteristic of textual or visual content that reflects an intended emotional or stylistic attitude, such as light, serious, joyful, or melancholic.

The term “scene structure” refers to an arrangement and progression of scenes within a storyline, including ordering, emphasis, and transitions among narrative segments.

The term “modification instruction” refers to natural language data received from the user terminal that specifies a desired change to at least one page or scene of an already generated visual expression.

The term “partial update” refers to a process in which only a subset of pages or scenes and their associated text and image data within a visual expression are regenerated and replaced, without regenerating the entire visual expression.

In one embodiment, a server cooperates with a user terminal operated by a user to implement the claimed system. The server comprises at least one hardware processor, a main memory, a non-volatile storage device, and a network interface. The server executes an operating system such as a general-purpose server operating system and application software including a language processing unit, a data analysis unit, a layout generation unit, an emotion analysis unit, and interfaces to external or internal generative AI models. The user terminal comprises a processor, a memory, a display, an input interface, and a communication interface, and executes an application configured to send input information to the server and to display generated visual expressions.

The user uses the terminal to input natural language instructions, to designate a page count, and to optionally select past visual information, location information, activity record information, and schedule information. The terminal executes a user interface module implemented, for example, in a mobile operating system environment or a web browser. The terminal presents text input fields, selection widgets, and file selection dialogs. The terminal formats user input as structured data, for example as a set of key-value pairs, and transmits the structured data to the server via a network using a secure transport protocol.

The server receives the structured data at the network interface and stores the raw input into a storage subsystem. The server uses a relational data structure, such as tables in a relational database management system, to store textual instructions, page count designations, and references to media assets. The server stores image and video data in an object storage subsystem, indexed by user identifiers and time stamps. The server uses a columnar or time-series table to store location information and activity record information, and uses a calendar-like table to store schedule information. By structuring the heterogeneous input information into separate but linked data structures, the server enables efficient indexed retrieval and time-ordered aggregation.

The server uses the language processing unit to analyze natural language instructions. The language processing unit is implemented as a software module that employs both rule-based parsing and a neural network language model. The rule-based parser uses tokenization, part-of-speech tagging, and pattern matching to identify numerals associated with words such as “pages” and to identify candidate event phrases. The neural network language model is, for example, a transformer-based model trained on textual corpora to perform named entity recognition and emotion-phrase detection. The neural model encodes the input text into vector representations using word and position embeddings, passes the vectors through multiple self-attention layers with learned weights, and outputs probabilities over entity and emotion labels. The server uses these probabilities to extract a focused event, a target page count, and emotion-related expressions with higher accuracy than purely rule-based extraction.

The server uses the data analysis unit to integrate past visual information, location information, activity record information, and schedule information. The data analysis unit is implemented as a set of processing modules in a high-level programming environment such as a scripting language with data analysis libraries (for example, libraries for table processing and numerical operations). The server reads relevant rows from the relational database, joins records by user and time stamp, sorts the records chronologically, and aggregates them into summarized life information. The summarized life information is stored as a time-segmented sequence where each segment contains a list of locations, activities, and optionally associated media identifiers. The server may compute statistics such as frequency of visits to a location or co-occurrence of activities, and may extract representative events based on such statistics. By performing aggregation and feature extraction at the server, the system reduces the dimensionality of the raw data and improves cache locality and query performance, which results in more efficient subsequent use by generative AI models.

The server uses the extracted event, target page count, summarized life information, and emotion-related expressions to construct a prompt sentence for a text-type generative AI model. The server assembles the prompt sentence by concatenating template phrases with dynamically generated content derived from the analysis results. For example, the server generates a prompt sentence such as:
“Generate a detailed storyline for a 10-page manga about a high school graduation ceremony. The overall emotion is ‘deeply moved’ and ‘nostalgic’. For each of the 10 pages, output a short description of the main scene, including characters, setting, and emotional focus.”
or
“Using the following summarized travel data (cities visited, key activities, dates) and the overall emotion ‘joy’, generate a 6-page comic storyline about the user's summer trip. For each page, describe one scene that emphasizes fun, discovery, and warm memories.”
or
“Create a storyline for a Halloween night adventure. The output must be structured into exactly 8 scenes, one for each comic page, with a spooky yet fun tone.”
or
“Theme: high school graduation, emotion: deeply moved and nostalgic, pages: 10. Generate a touching manga storyline where each page focuses on one key moment of the graduation day.”
or

“Based on the event ‘my first date’ and the emotions ‘excitement’ and ‘expectation’, generate a romantic storyline divided into 6 scenes, each showing nervous but happy feelings.”The server transmits the prompt sentence to a text-type generative AI model. In one embodiment, the text-type generative AI model is a transformer-based language model deployed on the same server or on an external computing resource. The model includes layers of self-attention and feed-forward sublayers, trained using a large text corpus with an auto-regressive objective. During generation, the model tokenizes the prompt sentence using a subword tokenizer, converts tokens into embeddings, processes them through multiple transformer layers, and at each step selects the next token based on a probability distribution produced by the final layer. The server configures model parameters such as temperature and top-k or top-p sampling thresholds to control trade-offs between diversity and determinism. Because the server uses a structured prompt sentence with explicit page count constraints and emotion instructions, the model is guided to produce a storyline divided into a specific number of scene units, which improves alignment with the requested page structure and reduces the need for repeated prompt refinement.

The server receives the generated storyline as an ordered sequence of text segments. Each text segment corresponds to a page or a scene unit and includes a narrative description of the main scene. The server analyzes each segment to derive visual description information. The server uses pattern rules and a secondary language model to extract character descriptions, locations, objects, and emotional cues from each segment. The server enriches these extractions with metadata from summarized life information, such as mapping “school gym” scenes to a known location entity or linking “summer trip” scenes to actual cities and dates. The server constructs a visual description record for each page or scene, containing fields for actors, background environments, objects, and emotional expressions. This representation is stored in a structured format in memory or a document database, which allows the server to access and modify each scene independently.

The server converts each visual description record into an image prompt sentence for an image-type generative AI model. The server composes the image prompt sentence by combining description of actors, backgrounds, and objects with style instructions and emotional tone. For example, the server generates prompt sentences such as:
“Manga comic style illustration. Page 1: four high-school students in uniforms outside the school gate at sunrise, cherry blossoms falling, smiling and a little nervous, soft warm colors.”
“Anime style illustration. Page 5: main character giving a speech on stage in the school gym, tears in eyes, classmates watching with gentle smiles, sunset light through windows, deeply moving atmosphere.”
“Fantasy manga style illustration. Page 1: a young magician standing on a hill overlooking a medieval fantasy city at sunrise, excited expression, vibrant colors.”

By structuring the image prompt sentence from the visual description record, the server ensures that the image-type generative AI model receives consistent and detailed instructions, which improves image coherence and reduces variation between runs.

The server uses an image-type generative AI model implemented, for example, as a diffusion-based neural network. The model may be implemented using a deep learning framework such as a general-purpose tensor library and executed on one or more graphics processing units. The diffusion model samples an initial noise image and iteratively refines it according to learned denoising functions conditioned on text embeddings of the image prompt sentence. During training, the model minimizes a loss function that measures the difference between true images and predicted denoised images at multiple noise levels. During inference, the model uses text encoders to convert the image prompt sentence into a conditioning vector and runs a fixed number of denoising steps. By constraining the number of steps and using optimized tensor operations, the server achieves reduced latency and predictable computational cost for each generated image.

The server generates one or more images per scene or page and stores the image data in an image repository. The server links each image to its corresponding scene record, allowing the layout generation unit to assemble scenes in a consistent order. The layout generation unit constructs a multi-page visual expression, such as a comic or an illustrated story. The layout generation unit uses page templates, panel grids, and text-field regions. The server selects a template corresponding to the target page count and uses the template to place images and optionally captions derived from the storyline. The server renders pages into digital documents such as portable document files or web-ready markup. The server uses rendering libraries to merge images and text into final output files.

The user terminal downloads or streams the final visual expression and displays it via a viewing module. The terminal renders pages sequentially and allows the user to scroll, swipe, or otherwise navigate between pages. The terminal may allow zooming or toggling captions. The user may evaluate the generated work and provide modification instructions. For example, the user may request: “Regenerate page 3 with a darker mood” or “Make the last scene happier.” The terminal captures such instructions and sends them to the server in association with a particular page or scene.

The server receives modification instructions and performs partial regeneration. The server identifies the corresponding scene record, reconstructs or adjusts the prompt sentence for that scene, and regenerates only the storyline and image data for that scene using the text-type and image-type generative AI models. Because scene records are independent and the server maintains clear mapping between scenes and pages, the server does not need to regenerate the entire storyline or all image data. The server replaces only the affected image and, when necessary, locates and replaces associated text. This partial update mechanism significantly reduces computational cost, bandwidth usage, and latency, thereby improving responsiveness from the user's perspective and the scalability of the overall system.

The server also incorporates an emotion analysis unit in certain embodiments. The user terminal may capture facial information using a camera and voice information using a microphone, in addition to text input. The server receives these multimodal signals and uses pre-trained neural networks to estimate an emotional state. For example, the server may use a convolutional neural network with multiple convolutional and pooling layers followed by fully connected layers to classify facial expressions. The server may use a recurrent or transformer-based network to analyze tone and prosody from audio signals. The server may use a sentiment classification model to analyze user text. The server combines outputs from these models using a weighted fusion scheme or a small feed-forward network to produce a final emotional state vector indicating emotion category and intensity. The server passes this emotional state vector into the prompt construction process, explicitly modifying phrases that describe tone and emotion. By feeding emotion estimates into both text and image prompt sentences, the system modulates the style and content of the generated story and images in a way that is consistent across scenes.

The use of these specific modules and data structures yields technical effects beyond mere automation of human creative tasks. Because the server structures heterogeneous input information into summarized life information and scene records, the pipeline reduces the size of data passed into the generative AI models while maintaining context. This leads to improved computational efficiency at the model interface and reduces network load when models are hosted on separate computing resources. The explicit page count constraint encoded in the prompt sentence guides the language model to produce a fixed number of scene units, eliminating repeated trial-and-error API calls that would otherwise be required to adjust length, thereby reducing processor cycles and network traffic. The emotion-based adjustment of prompt sentences and of scene structure uses machine-learned scoring of emotional consistency, which improves the predictability of output tone compared to manual rewriting.

In addition, the partial regeneration mechanism improves both performance and accuracy. By regenerating only the specified page or scene, the server minimizes recomputation and avoids unnecessary changes to unaffected content, which ensures stability in the rest of the visual expression. The server maintains a mapping between scene indices, original prompt sentences, and generated outputs. When a modification instruction is received, the server retrieves only the relevant scene record and reuses existing context, which reduces the number of operations in the language and image models. This approach is different from conventional batch re-generation and results in lower latency and resource usage, improving the technical performance of the system.

The server may employ additional optimization techniques. For example, the server may cache intermediate embeddings for recurring characters or backgrounds and reuse them across multiple image generations to reduce duplication. The server may maintain a record of past prompt sentences and associated evaluation scores to refine future prompt construction using a reinforcement or bandit-like algorithm, which gradually improves generation quality without retraining the large models themselves. The server may parallelize image generation across multiple graphics processing units, assigning each page or scene to a different device, which shortens overall generation time.

Alternative embodiments may vary in the specific machine learning architectures used. The text-type generative AI model may be implemented as a bidirectional encoder-decoder structure or as a sequence-to-sequence transformer. The image-type generative AI model may be a generative adversarial network instead of a diffusion model. The emotion analysis unit may use other classifiers such as support vector machines or gradient-boosted trees on top of features extracted by neural networks. The layout generation unit may target other formats, such as virtual reality environments, by placing generated images into a three-dimensional scene graph instead of a flat page.

In all embodiments, the user uses the terminal to provide natural language instructions and optional media, the terminal communicates structured data to the server, and the server performs structured analysis, prompt sentence generation, interaction with text-type and image-type generative AI models, scene-level representation, layout construction, and partial regeneration. By defining a specific data flow and module interaction pattern that exploits intermediate representations (summarized life information, scene units, visual description information, and prompt sentences) and by integrating emotion-aware control and page-count-aware control into generative AI workflows, the system improves the efficiency, consistency, and controllability of computer-based generation of narrative visual content.

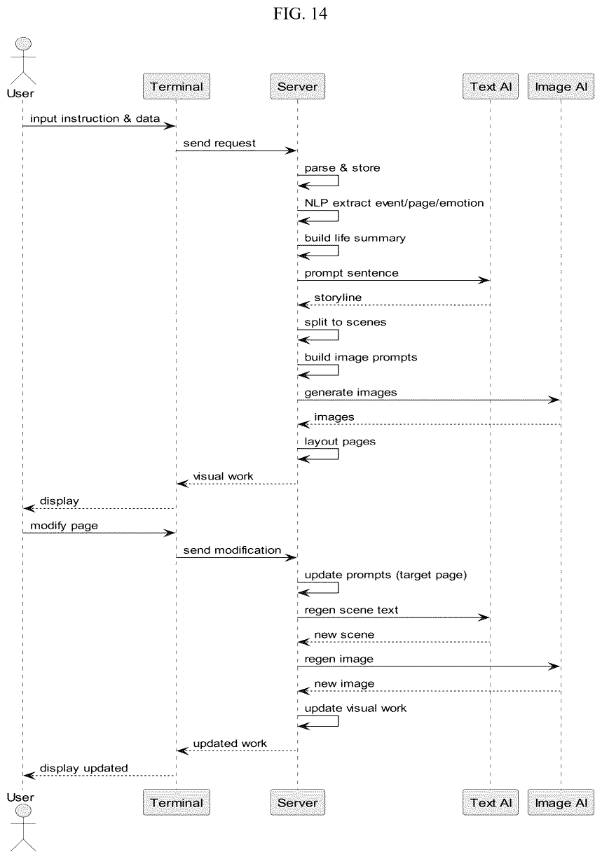

The following describes the processing flow using FIG. 14.
Step 1:

User operates the terminal to input instructions and select data.

User enters natural language instructions such as a desired theme, an event to be depicted, and an optional emotion, and designates a page count (for example “10 pages”). User optionally selects past visual information (photos, videos), location information (time periods for GPS logs), activity record information, and schedule information from interfaces on the terminal.

Input: User's typed text, page count selection, selected media files and time ranges.

Output: A structured set of user inputs stored in the terminal's memory (for example key-value pairs representing text, page count, file references, and timestamps).
Step 2:

Terminal formats and transmits the user inputs to the server.

Terminal converts the structured set of user inputs into a request object, serializes text fields, encodes file data or file references, and attaches metadata such as user ID and session ID. Terminal sends the request over a secure communication channel to the server.

Input: Structured user inputs stored locally at the terminal.

Output: A network request message containing natural language instructions, page count, and references or binary data for past visual information, location logs, activity records, and schedule items, delivered to the server.
Step 3:

Server receives and stores the raw input information.

Server parses the incoming request message, validates its schema, and separates different categories of information (text, page count, media, logs, schedule). Server inserts text fields and page count into database tables, stores media in an object repository, and indexes location and schedule data by user ID and timestamps.

Input: Network request message from the terminal.

Output: Normalized records stored in the server's database and storage subsystems, including a new request identifier that links all related data.
Step 4:

Server analyzes natural language instructions using a language processing unit.

Server retrieves the text instructions for the request identifier and passes them to the language processing unit. Server tokenizes the text, applies part-of-speech tagging, and runs a neural language model to detect candidate events, numbers associated with “pages,” and emotion-related expressions. Server applies rules to associate detected numbers with the page count concept and selects the most probable event phrase and emotion terms from the model outputs.

Input: Text instructions associated with the request identifier.

Output: Extracted values including a focused event description, a target page count, and a set of emotion-related expressions, stored as structured fields for the request.
Step 5:

Server aggregates heterogeneous past data into summarized life information.

Server uses the data analysis unit to query past visual information, location information, activity record information, and schedule information linked to the user. Server joins records by time, sorts them chronologically, and groups them into segments (for example by day, trip, or activity cluster). Server computes simple statistics (frequency of visits, duration of activities) and selects representative events, then condenses the results into a time-series summary describing key places, actions, and associated timestamps.

Input: Database records for visual information, location logs, activity records, and schedule entries linked to the user.

Output: Summarized life information for the user, stored as an ordered sequence of segments with associated attributes, linked to the request identifier.
Step 6:

Server estimates the user's emotional state using the emotion analysis unit.

Server collects available affective signals for this request, including emotion-related expressions extracted from text, and optionally facial images or voice recordings received from the terminal. Server feeds text into a sentiment classifier, feeds facial images into a convolutional neural network classifier, and feeds voice spectrograms into an audio emotion model. Server combines these outputs using weighted averaging or a small fusion network to produce an emotional state vector indicating category (for example joy, sadness, nostalgia) and intensity.

Input: Emotion-related text expressions, and optionally facial and voice data associated with the request.

Output: An emotional state vector that numerically represents the estimated emotion for the user in connection with this request.
Step 7:

Server constructs a prompt sentence for a text-type generative AI model.

Server uses the extracted event, target page count, summarized life information, and the emotional state vector to compose a detailed textual instruction. Server fills a template with dynamic elements, including the event label, page count, emotional tone, and a short summary of relevant life segments. Server concatenates these pieces into one coherent prompt sentence, ensuring it explicitly specifies the number of pages or scenes and the desired emotional character.

Input: Focused event description, target page count, summarized life information, emotional state vector.

Output: A structured prompt sentence in natural language to be used as input to the text-type generative AI model, stored as part of the request context.
Step 8:

Server generates a storyline with a text-type generative AI model.

Server sends the prompt sentence to the text-type generative AI model via an invocation interface. The model tokenizes the prompt, processes it through transformer layers, and generates a continuation constrained to contain a specific number of scene segments. Server configures generation parameters to limit length and enforce an enumerated list of scenes or pages. Server receives the generated text and parses it into scene units, typically by detecting list markers or page indices.

Input: Prompt sentence for the text-type generative AI model.

Output: A storyline divided into scene units, each unit containing a narrative description for a page or scene, stored as an ordered list associated with the request.
Step 9:

Server validates and, if necessary, refines the storyline.

Server checks that the number of scene units matches the target page count and that each scene refers to the focused event. Server scans the text for emotional cues and compares them to the emotional state vector; if a mismatch is detected (for example, tone is too neutral), Server may generate a secondary refining prompt and call the text-type generative AI model again with instructions to adjust tone while preserving structure. Server then updates the storyline list with the refined text.

Input: Initial storyline divided into scene units, target page count, focused event, emotional state vector.

Output: A validated and, if necessary, refined storyline where each scene corresponds to one page and reflects the requested event and emotion, stored in structured form.
Step 10:

Server derives visual description information for each scene.

Server iterates over each scene unit in the storyline and processes the text using extraction rules and a secondary language model to identify actors, background environments, important objects, and emotional cues (for example “teary-eyed,” “dark alley,” “graduation stage”). Server may cross-reference summarized life information to map textual locations to known places. Server builds a visual description record for each scene, containing fields such as character attributes, setting, props, and suggested color or lighting mood.

Input: Scene-level storyline units and summarized life information.

Output: A list of visual description records, one per scene, specifying actors, backgrounds, objects, and emotional expressions for each scene.
Step 11:

Server composes image prompt sentences for an image-type generative AI model.

Server converts each visual description record into an image prompt sentence that describes the desired illustration. Server formats the sentence to include art style (for example “manga comic style” or “anime style”), scene content (who and where), key objects, and emotional atmosphere (for example “soft warm colors,” “spooky dim lighting”). Server ensures the language is concise yet detailed enough for consistent image synthesis.

Input: Visual description records for all scenes.

Output: A list of image prompt sentences, each mapped to a particular scene or page index.
Step 12:

Server generates images using an image-type generative AI model.

Server sends each image prompt sentence to an image-type generative AI model, such as a diffusion-based model, possibly running on one or more graphics processing units. Server encodes the prompt sentence into a text embedding, initializes a noise tensor, and runs a fixed number of denoising steps conditioned on the embedding. Server adjusts model parameters such as guidance scale to balance adherence to the prompt and visual diversity. Server repeats this process for each scene, optionally in parallel, and stores the resulting image files.

Input: List of image prompt sentences for all scenes.

Output: A corresponding list of image data items (for example raster image files) representing visual content for each page or scene, stored in an image repository with scene indices.
Step 13:

Server assembles the storyline and images into a multi-page visual expression.

Server passes the storyline and associated images to the layout generation unit. Server selects a layout template based on the target page count and desired format (for example single-panel per page). Server places each image on the appropriate page, optionally adding captions or text boxes derived from scene descriptions. Server then renders the pages into a final output format, such as a paginated document or a set of page images with metadata.

Input: Validated storyline (per scene) and corresponding image data items.

Output: A structured visual expression object containing ordered pages with images and optional text, stored in a format suitable for transmission to the terminal.
Step 14:

Server transmits the visual expression to the terminal.

Server prepares a response that includes metadata (title, page count, identifiers) and the visual expression content (for example a document file or a list of images). Server may compress the data and apply appropriate headers, then sends the response over the network connection back to the terminal.

Input: Visual expression object stored at the server.

Output: A response message containing the complete visual expression, delivered to the terminal for presentation.
Step 15:

Terminal displays the visual expression and collects user feedback.

Terminal receives the response from the server, stores the visual expression in local memory, and invokes a viewer module. Terminal renders each page on the display and provides navigation controls for the user. User views the visual expression and may decide to accept it or to request modification of specific pages or scenes by entering new natural language instructions (for example “make page 2 brighter and happier”).

Input: Response message containing the visual expression, and optional new user input describing desired modifications.

Output: A displayed visual expression on the terminal screen, and, when modifications are requested, a new structured modification request ready to be sent to the server.
Step 16:

Server performs partial regeneration based on modification instructions.

Server receives a modification request specifying one or more pages or scenes and new textual instructions, including possibly a change of tone or content. Server identifies the corresponding scene records and reconstructs or adjusts the prompt sentence and image prompt sentence only for those scenes. Server calls the text-type generative AI model and image-type generative AI model to regenerate the storyline unit and image data for the targeted scenes, then replaces only the affected entries in the storyline, visual description records, and image repository.

Input: Modification request specifying target pages or scenes and updated natural language instructions.

Output: Updated storyline and image data for the specific pages or scenes, and an updated visual expression that incorporates the regenerated content while leaving other pages unchanged.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve ve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

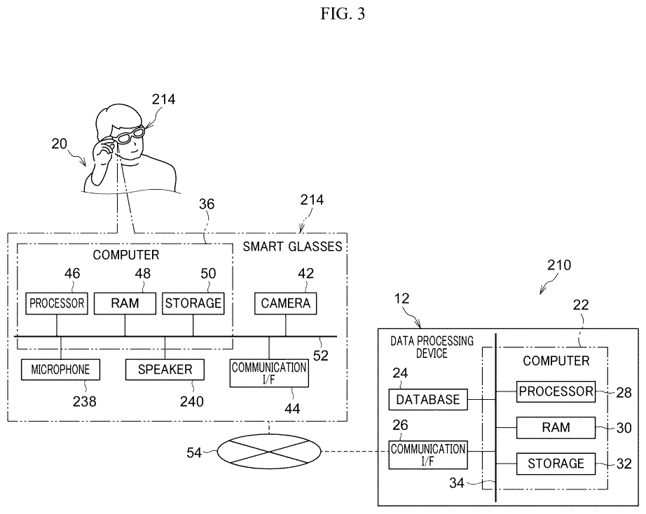

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

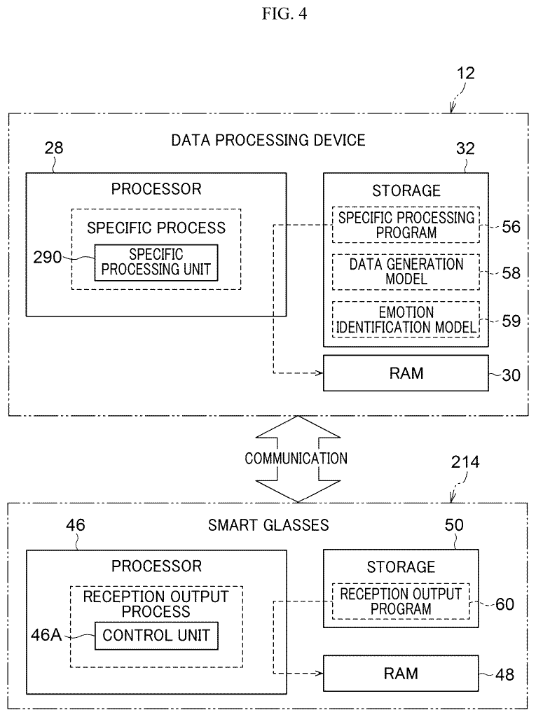

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

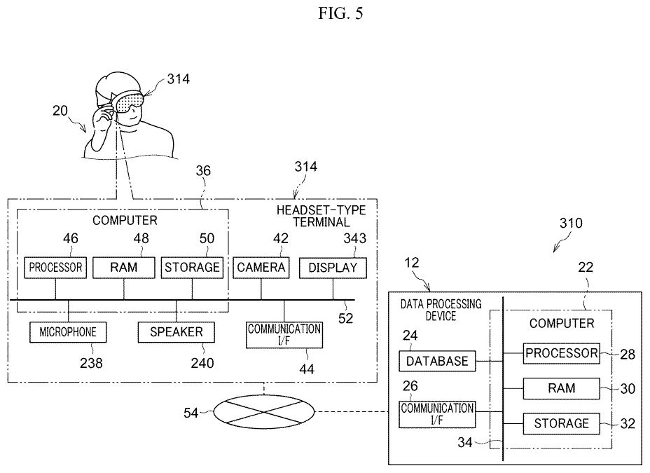

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

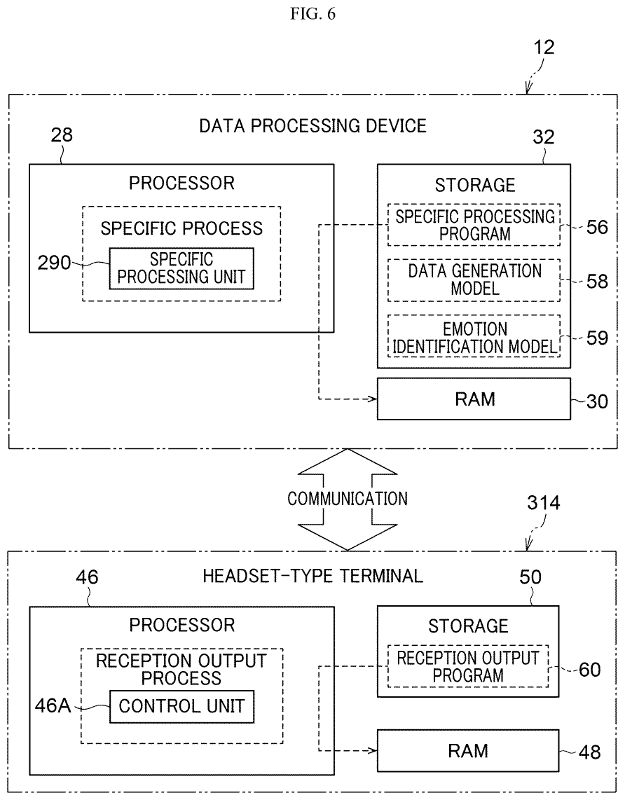

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

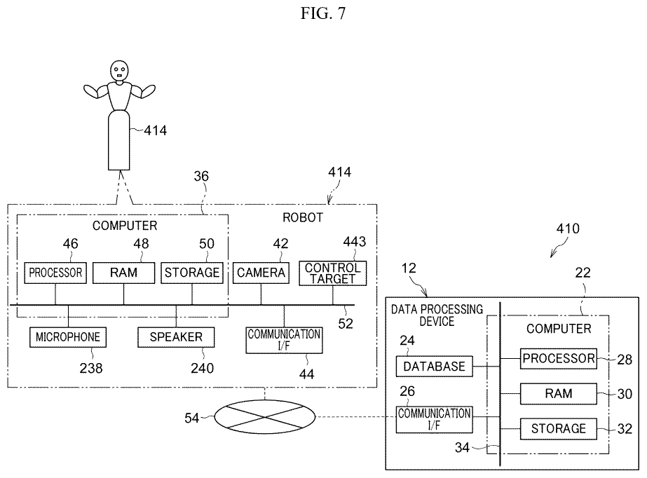

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

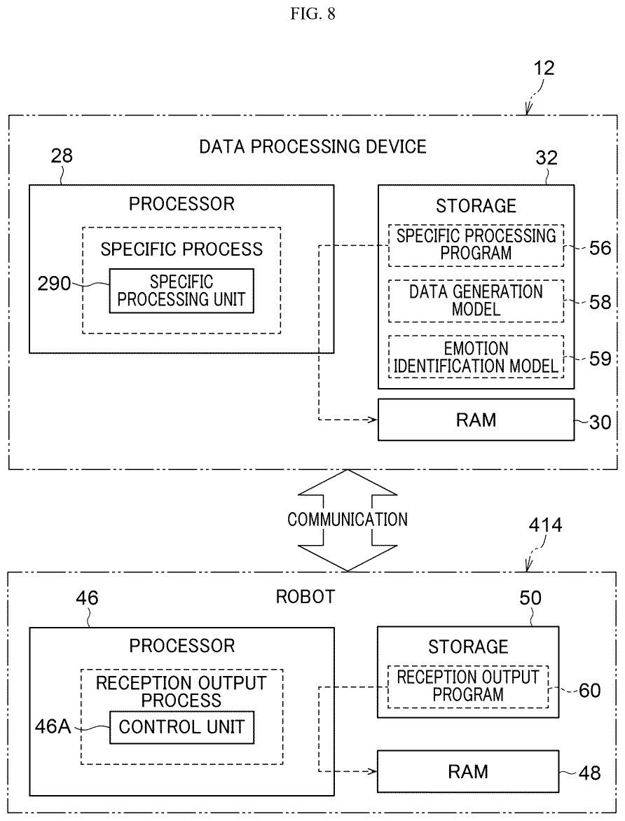

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

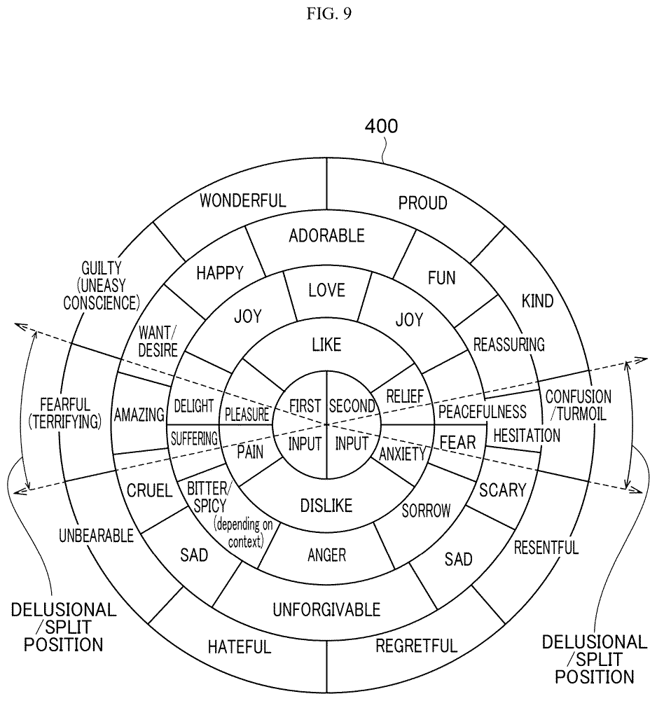

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

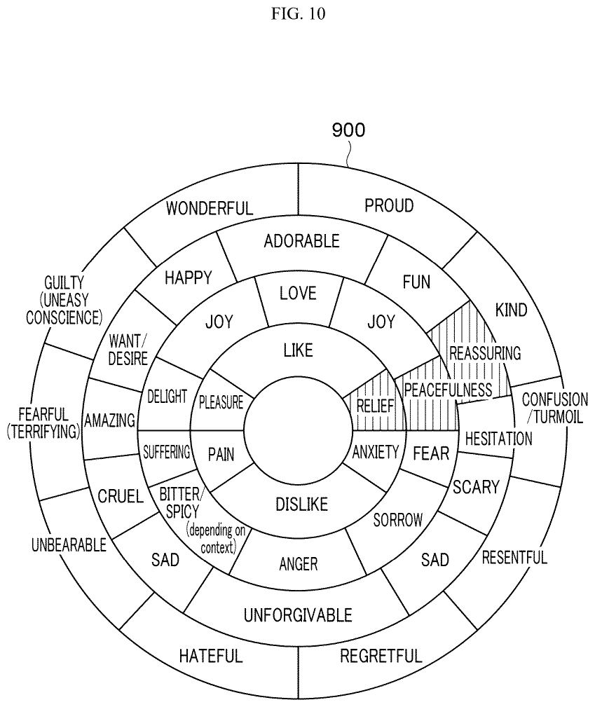

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor and a storage device,
wherein the processor is configured to
acquire multiple types of time-series information including past visual information, positional information, record information, and schedule information, and store the acquired multiple types of time-series information in the storage device,
analyze the multiple types of time-series information stored in the storage device by using an information processing program to identify visit locations and stay time periods from the positional information, perform natural language processing on the record information and the schedule information to extract activity contents and events, and associate the visit locations, the stay time periods, the activity contents, and the events with one another to structure them as time-series episode information,
input the structured episode information and a prompt sentence expressed in natural language as preconditions, provide text information including the prompt sentence to a generative information processing model, and generate a storyline that narrates activities and events of a specific person in chronological order,
divide the generated storyline into a plurality of scene units or screen units based on association between the generated storyline and the visual information, and determine, for each of the scene units or the screen units, display text including explanatory text and dialogue text and corresponding visual elements, and
lay out a plurality of component images based on the determined display text and the visual elements by using an image processing program, and generate output data in which the storyline is represented as a visual expression.

### (Supplementary 2)

The system according to supplementary 1,
wherein the processor is configured to receive, as the prompt sentence, text including a request in natural language by a user that specifies at least one of a period, a location, or an event, extract, from the storage device, the episode information corresponding to the request, and instruct the generative information processing model to generate the storyline by using the extracted episode information.

### (Supplementary 3)

The system according to supplementary 1,
wherein the processor is configured to acquire information relating to an emotional state of the user, analyze the information relating to the emotional state to obtain an emotion analysis result, and adjust at least one of selection of the events, length of narration, or tone of expression in the storyline based on the emotion analysis result.

### Application Example 1

### (Supplementary 1)

A system comprising a processor,
wherein the processor is configured to
acquire, from an information terminal connected to an information processing apparatus, time-series information including past visual information, location information, record information, and schedule information, together with period information or event information specified by a user, and extract the time-series information based on the period information or the event information,
integrate the extracted time-series information based on time information and spatial information, associate the visual information, the location information, the record information, and the schedule information with one another in chronological order, and generate narrative structure information including scene information, place information, event information, and emotion information based on an integration result,
generate, in a natural language, a prompt sentence for input to a generative artificial intelligence model based on the narrative structure information, transmit the prompt sentence to the generative artificial intelligence model, and cause the generative artificial intelligence model to generate storyline information representing the narrative structure information, convert the storyline information into structured data interpretable by a visual expression generation application program, and generate visual expression instruction information including page information, panel information, background information, element information, and text information, and
input the visual expression instruction information to the visual expression generation application program, control the visual expression generation application program to generate visual content including a plurality of image data or document data, and provide the visual content to the information terminal.

### (Supplementary 2)

### The System According to Supplementary 1,

wherein the processor is configured to
analyze emotion expressions included in the record information or the storyline information when generating the narrative structure information, adjust the narrative structure information so as to emphasize or de-emphasize the scene information or the event information based on the emotion expressions, and generate the prompt sentence based on the adjusted narrative structure information.

### (Supplementary 3)

The system according to Supplementary 1,
wherein the processor is configured to
analyze focus-target specification information expressed in a natural language and input from the information terminal, identify period information or event information corresponding to the focus-target specification information from the time-series information, and generate the prompt sentence based on the identified period information or event information and the integrated time-series information, and supply the prompt sentence to the generative artificial intelligence model to cause the generative artificial intelligence model to generate the storyline information.

### Example 2

### (Supplementary 1)

A system comprising a processor,
wherein the processor is configured to
receive, as input information, request information in natural language transmitted from a user terminal and additional information including past visual information, position information, record information, and schedule information, and normalize the input information, perform language detection and machine translation as needed, and generate analysis text data, perform natural language processing including morphological analysis, part-of-speech tagging, named entity extraction, and emotion analysis on the analysis text data to generate structured data including an event, an actor, a place, a time, an emotion, and a user preference, and generate a story line describing a life of an individual based on the structured data, automatically generate a prompt sentence for input to a generative AI model based on the structured data and the story line in accordance with a template or rule, input the prompt sentence to the generative AI model to cause the generative AI model to generate or supplement a story line, and determine an output result of the generative AI model as a finalized story line,
divide the finalized story line into scenes, generate visual description data for each scene including a background, an appearance, a posture, an expression, a placement, a main action, a spoken line, and an emotion of an actor, and convert the visual description data into layout data associated with pages and panels, and
input the layout data to a drawing software program or an image generation model, cause automatic generation of a visual expression including a plurality of pages in accordance with the layout data, output the generated visual expression as an image file or a document file, and store and provide the visual expression in a format deliverable to the user terminal.

### (Supplementary 2)

The system according to supplementary 1,
wherein the processor is configured to
perform emotion analysis on the natural language processing and on an output from the generative AI model, and automatically adjust at least one of the story line and the visual description data based on a user emotion tendency and an emotion estimation for each scene, thereby dynamically controlling an atmosphere, a composition, and a number of pages of the visual expression.

### (Supplementary 3)

The system according to supplementary 1,
wherein the processor is configured to
when a user inputs, from the user terminal, a target event to be focused on in natural language, automatically generate the prompt sentence using the structured data including the event, the actor, the emotion, and the user preference extracted by the natural language processing, transmit the prompt sentence to the generative AI model to instruct the generative AI model to generate or extend the story line, and automatically generate the story line and the visual expression corresponding to a request of the user in natural language.

### Application Example 2

### (Supplementary 1)

A system comprising a processor,
wherein the processor is configured to
receive, from a user terminal, a plurality of types of input information including natural language instructions, a page count designation, and past visual information, location information, activity record information, and schedule information,
analyze the received natural language instructions by using a language processing unit to extract a focused event, a target page count, and emotion-related expressions, and integrate the plurality of types of input information by using a data analysis unit to generate summarized life information for each user in time series,
generate, on the basis of the extracted event and the target page count, the summarized life information, and the emotion-related expressions, a prompt sentence to be input to a text-type generative AI model,
input the prompt sentence to the text-type generative AI model and generate a storyline that is divided into a plurality of scene units corresponding to the target page count and that reflects the event and the summarized life information,
analyze the storyline for each page or for each scene and generate, for each page or each scene, visual description information including actors, background environments, objects, and emotional expressions, and generate, on the basis of the visual description information, an image prompt sentence to be input to an image-type generative AI model,
input the image prompt sentence to the image-type generative AI model and generate a plurality of image data items corresponding to the respective pages or scenes of the storyline, and
construct, by using a layout generation unit, a visual expression having a page composition corresponding to the target page count by using the generated storyline and the plurality of image data items, and provide the visual expression to the user terminal.

### (Supplementary 2)

The system according to supplementary 1,
wherein the processor is configured to
input facial information, voice information, and text information acquired from the user terminal to an emotion analysis unit to estimate an emotional state of a user, adjust at least one of tone, scene structure, and content of the prompt sentence and the storyline in accordance with the emotional state, and generate the image prompt sentence and the visual expression reflecting a result of the adjustment.

### (Supplementary 3)

The system according to supplementary 1,
wherein the processor is configured to regenerate at least a part of the prompt sentence and the image prompt sentence corresponding to a specified page or scene on the basis of a modification instruction in natural language received from the user terminal, regenerate only a storyline and image data of the specified page or scene by using the text-type generative AI model and the image-type generative AI model, and partially update the visual expression on the basis of a regeneration result.

What is claimed is:

1. A system comprising:
circuitry configured to:
receive, via a communication interface coupled to a packet-switched network, input data from a terminal device, the input data including past visual data, location information, record data, and schedule information;
analyze the received input data and generate, using an information processing program, a storyline that depicts a life of a specific individual based on the analyzed input data; and
transmit, via the communication interface, output data including a visual representation created based on the generated storyline using a generative AI model to the terminal device.

2. The system according to claim 1, wherein the circuitry is configured to identify visit locations and stay time periods from the location information, and perform natural language processing on the record data and the schedule information to extract activity contents and events.

3. The system according to claim 2, wherein the circuitry is configured to associate the visit locations, the stay time periods, the activity contents, and the events with one another to structure them as time-series episode information, and generate the storyline by providing the time-series episode information and a prompt sentence to the generative AI model.

4. The system according to claim 3, wherein the circuitry is configured to divide the generated storyline into a plurality of scene units based on association between the storyline and the past visual data, and determine, for each of the scene units, display text including explanatory text and dialogue text and corresponding visual elements.

5. The system according to claim 4, wherein the circuitry is configured to lay out a plurality of component images based on the determined display text and visual elements using an image processing program, and generate the visual representation in which the storyline is expressed as a page-structured output.

6. The system according to claim 1, wherein the circuitry is configured to analyze an emotion of a user and adjust the storyline based on a result of the analysis.

7. The system according to claim 6, wherein the circuitry is configured to infer an emotional state of the user from content of the record data and from user feedback received via the communication interface, and modify selection, order, or emphasis of events in the storyline based on the inferred emotional state.

8. The system according to claim 7, wherein the circuitry is configured to input facial information, voice information, and text information received from the terminal device to an emotion analysis unit to estimate the emotional state of the user, and adjust at least one of tone, scene structure, and content of the storyline in accordance with the estimated emotional state.

9. The system according to claim 1, wherein the circuitry is configured to receive, from the terminal device in natural language, a specification of an event on which a user desires to focus, and generate a prompt sentence that instructs the generative AI model to generate the storyline based on the specified event.

10. The system according to claim 9, wherein the circuitry is configured to parse the natural language specification to identify a relevant time period, location, or event category within the input data, and construct one or more prompt sentences for the generative AI model based on the identified time period, location, or event category.

11. The system according to claim 1, wherein the circuitry is configured to extract the input data from a storage device based on period information or event information specified by the user, and integrate the extracted input data based on time information and spatial information to associate the past visual data, the location information, the record data, and the schedule information in chronological order.

12. The system according to claim 11, wherein the circuitry is configured to generate narrative structure information including scene information, place information, event information, and emotion information based on an integration result, and generate, in a natural language, a prompt sentence for input to the generative AI model based on the narrative structure information.

13. The system according to claim 12, wherein the circuitry is configured to convert storyline information output by the generative AI model into structured data interpretable by a visual expression generation application, and generate visual expression instruction information including page information, panel information, background information, element information, and text information.

14. The system according to claim 1, wherein the circuitry is configured to normalize the input data, perform language detection and machine translation as needed, and generate analysis text data for subsequent processing.

15. The system according to claim 14, wherein the circuitry is configured to perform natural language processing including morphological analysis, part-of-speech tagging, named entity extraction, and emotion analysis on the analysis text data to generate structured data including an event, an actor, a place, a time, an emotion, and a user preference.

16. The system according to claim 1, wherein the circuitry is configured to receive, from the terminal device, a page count designation along with the input data, generate, based on the page count designation, a storyline divided into a plurality of scene units corresponding to a target page count, and generate image data for each scene unit using the generative AI model.

17. The system according to claim 16, wherein the circuitry is configured to receive, from the terminal device, a modification instruction in natural language specifying a page or scene, regenerate a prompt sentence and image data for only the specified page or scene, and partially update the visual representation based on a regeneration result.

18. A system comprising:
circuitry configured to:
receive, via a communication interface coupled to a packet-switched network, input data including past visual data, location information, record data, and schedule information from a terminal device, and store the input data in a storage device;
identify visit locations and stay time periods from the location information, perform natural language processing on the record data and the schedule information to extract activity contents and events, and associate the visit locations, the stay time periods, the activity contents, and the events with one another to structure them as time-series episode information;
generate a prompt sentence based on the time-series episode information and provide the prompt sentence to a generative AI model to generate a storyline depicting a life of a specific individual;
divide the generated storyline into scene units, determine display text and visual elements for each scene unit, and generate, using an image processing program, a visual representation in which the storyline is expressed as a page-structured output; and
transmit the visual representation to the terminal device via the communication interface.

19. The system according to claim 18, wherein the circuitry is configured to analyze an emotion of a user based on content of the record data received from the terminal device, and adjust at least one of tone, scene structure, and content of the storyline in accordance with the analyzed emotion prior to generating the visual representation.

20. A method comprising:
receiving, via a communication interface coupled to a packet-switched network, input data from a terminal device, the input data including past visual data, location information, record data, and schedule information;
analyzing the received input data and generating, using an information processing program, a storyline that depicts a life of a specific individual based on the analyzed input data; and
transmitting, via the communication interface, output data including a visual representation created based on the generated storyline using a generative AI model to the terminal device.
